(19) United States
(12) Patent Application Publication
(10) Pub. No.: US 2025/0076653 A1
(43) Pub. Date: Mar. 6, 2025

(54) LIGHT GUIDE PLATE AND IMAGE DISPLAY DEVICE

(71) Applicant: SONY GROUP CORPORATION, Tokyo (JP)

(72) Inventors: Kazue SHIMIZU, Tokyo (JP); Christophe PEROZ, Tokyo (JP); Sebastien DE CUNSEL, Ivry-sur-Seine (FR)

(73) Assignee: SONY GROUP CORPORATION, Tokyo (JP)

(21) Appl. No.: 18/727,168

(22) PCT Filed: Sep. 26, 2022
(86) PCT No.: PCT/JP2022/035575

§ 371 Date: Jul. 8, 2024

(30) Foreign Application Priority Data
Jan. 17, 2022 (JP) 2022-005089

(51) Int. Cl. G02B 27/01

(52) U.S. Cl. CPC G02B 27/0172

(57) ABSTRACT

To improve image quality by improving light use efficiency and resolution. Provided is a light guide plate including an incident part configured to diffract incident light into the light guide plate, a path configured to guide the light diffracted into the light guide plate by the incident part by internal total reflection, and an output part configured to diffract the light guided by the path and output the light toward an observer's pupil, the output part has a plurality of diffraction grating groups in a two-dimensional arrangement, the plurality of diffraction grating groups includes, in front view, at least one of a diffraction grating configured to diffract the light outward from the output part, a diffraction grating configured to diffract the light inwardly with respect to the output part, and a diffraction grating configured to diffract the light toward an observer's pupil.

### TECHNICAL FIELD

The present technology relates to a light guide plate and an image display device.

### BACKGROUND ART

In order to realize Cross Reality (XR) which includes Augmented Reality (AR), Virtual Reality (VR), and Mixed Reality (MR), light guide plates have been developed to project image light onto observer's pupils.

For example, PTL 1 to PTL 3 disclose features related to light guide plates with image qualities improved by improvement in light use efficiency.

### CITATION LIST

### Patent Literature

PTL 1: WO 2020/217044
PTL 2: U.S. Patent Application Publication No. 2021/0072534 (Description)
PTL 3: U.S. Patent Application Publication No. 2021/0209630 (Description)

### SUMMARY

### Technical Problem

The features disclosed in PTL 1 to PTL 3 are still susceptible to improvement in terms of image quality.

It is therefore a main object of the present technology to provide a light guide plate and an image display device that allow for improvement in image quality for example by improving light use efficiency and resolution.

### Solution to Problem

According to the present technology, provided is a light guide plate including an incident part configured to diffract incident light into the light guide plate, a path configured to guide the light diffracted into the light guide plate by the incident part by internal total reflection, and an output part configured to diffract the light guided by the path and output the light toward an observer's pupil, the output part has a plurality of diffraction grating groups in a two-dimensional arrangement, and the plurality of diffraction grating groups includes, in front view, at least one of a diffraction grating configured to diffract the light outward from the output part, a diffraction grating configured to diffract the light inwardly with respect to the output part, and a diffraction grating configured to diffract the light toward an observer's pupil.

The diffraction grating may diffract the light in a two-dimensional direction.

The sum of a lattice vector which the incident part has and a basic lattice vector which the output part has may be closed.

The diffraction grating groups arranged adjacent to each other may have lattice vectors substantially in the same direction.

The diffraction grating group may have a plurality of unit diffraction gratings in a two-dimensional arrangement.

The unit diffraction gratings may include a combination of periodic structures of diffraction gratings which the output part has.

The unit diffraction grating may have a shape which substantially continuously changes from one side to the other in a plane of the output part.

The diffraction grating groups may have different shapes according to locations in a plane of the output part.

The unit diffraction gratings may have different shapes according to locations in a plane of the output part.

The diffraction grating group may have a return diffraction grating configured to diffract the light inwardly with respect to the output part, and the return diffraction grating may have a pitch which is a value obtained by dividing, by an integer, the pitch of other diffraction gratings which the output part has.

The diffraction grating group including the return diffraction grating is provided outside of a region on which light from the path is incident and in an outer periphery of the output part.

The return diffraction grating may have a stripe-like periodic structure.

The unit diffraction grating may have a hole pattern or a pillar pattern.

The output part may be provided on one or both surfaces of the light guide plate.

The output part may be provided in a location which is the same as or different from the incident part in a thickness-wise direction of the light guide plate.

The light guide plate may include one or more of the incident parts and one or more of the output parts.

The light guide plate may further include an extension part between the incident part and the output part, the extension part may have a plurality of diffraction grating groups in a two-dimensional arrangement, the plurality of diffraction grating groups may include, in front view, at least one of a diffraction grating configured to diffract the light outward from the output part, a diffraction grating configured to diffract the light inwardly with the respect to the output part, and a diffraction grating configured to diffract the light toward the output part.

The extension part and the output part may be arranged adjacent to each other.

The plurality of diffraction grating groups have a smaller spacing than the observer's pupil diameter.

The plurality of diffraction grating groups may have a spacing of 3.0 mm or less.

At least one of the diffraction grating groups may have a transition region at an end thereof, and the transition region may have a diffraction efficiency which is between a diffraction efficiency in an approximate center of the diffraction grating group and a diffraction efficiency in an approximate center of a diffraction grating group adjacent to the diffraction grating group. Furthermore, according to the present technology, an image display device including the light guide plate and an image forming unit that outputs image light to the light guide plate is provided.

According to the present technology, a light guide plate and an image display device that allow for improved image quality for example by improving light use efficiency and resolution can be provided. Meanwhile, advantageous effects are not necessarily limited to those described here and may be any of effects in the present disclosure.

### BRIEF DESCRIPTION OF DRAWINGS

FIG. 1 is a simplified front view of an exemplary configuration of a light guide plate 1 according to an embodiment of the present technology.

FIG. 2 is a concept diagram for illustrating examples of the lattice vectors of diffraction gratings of an incident part 2 and an output part 4 according to the embodiment of the present technology.

FIG. 3 is a simplified front view of an exemplary configuration of the output part 4 according to the embodiment of the present technology.

FIG. 4 is a simplified front view of an exemplary configuration of the incident part 2 and the output part 4 according to the embodiment of the present technology.

FIG. 5 is a simplified front view of an exemplary configuration of the output part 4 according to the embodiment of the present technology.

FIG. 6 indicates wavenumber space coordinates for depicting an exemplary design of a diffraction grating according to the embodiment of the present technology.

FIG. 7 indicates wavenumber space coordinates for depicting an exemplary design of a diffraction grating according to the embodiment of the present technology.

FIG. 8 indicates wavenumber space coordinates for depicting an exemplary design of a diffraction grating according to the embodiment of the present technology.

FIG. 9 is a simplified plan view of an exemplary configuration of a unit diffraction grating according to the embodiment of the present technology.

FIG. 10 is a simplified perspective view of examples of the shape of a diffraction grating that constitutes a unit diffraction grating 51 according to the embodiment of the present technology.

FIG. 11 indicates wavenumber space coordinates for depicting an exemplary design of a diffraction grating according to the embodiment of the present technology.

FIG. 12 is a simplified front view of exemplary configurations of a diffraction grating group 5 according to the embodiment of the present technology.

FIG. 13 is a simplified front view of an exemplary configuration of the diffraction grating group 5 according to the embodiment of the present technology.

FIG. 14 is a simplified plan view of exemplary configurations of the unit diffraction grating 51 according to the embodiment of the present technology.

FIG. 15 is a simplified plan view of exemplary configurations of the output part 4 according to the embodiment of the present technology.

FIG. 16 is a simplified side cross-sectional view of exemplary configurations of the light guide plate 1 according to the embodiment of the present technology.

FIG. 17 is a simplified side cross-sectional view of exemplary configurations of the light guide plate 1 according to the embodiment of the present technology.

FIG. 18 is a simplified front view of exemplary configurations of the incident part 2 and the output part 4 according to the embodiment of the present technology.

FIG. 19 is a concept diagram of examples of lattice vectors of diffraction gratings of the incident part 2, the output part 4, and an extension part 6 according to the embodiment of the present technology.

FIG. 20 is a simplified front view of an exemplary configuration of the diffraction grating group 5 according to the embodiment of the present technology.

FIG. 21 is a simplified front view of an exemplary configuration of the diffraction grating group 5 according to the embodiment of the present technology.

FIG. 22 is a simplified front view of an exemplary configuration of the diffraction grating group 5 according to the embodiment of the present technology.

FIG. 23 is a schematic view of examples of luminance distributions in an angle-of-view area A according to the present technology.

FIG. 24 is a table for indicating the correlation between the luminance of light and the grayscale.

FIG. 25 is a simplified front view of an exemplary configuration of the diffraction grating group 5 according to the embodiment of the present technology.

FIG. 26 is a graph for depicting an example of the diffraction efficiency of the diffraction grating group 5 according to the embodiment of the present technology.

FIG. 27 illustrates simulation results according to the present technology.

FIG. 28 is a block diagram of an exemplary configuration of an image display device 10 according to the embodiment of the present technology.

### DESCRIPTION OF EMBODIMENTS

Hereinafter, preferred embodiments for implementing the present technology will be described with reference to the drawings. The embodiments in the following description are examples of representative embodiments of the present technology, and the scope of the present technology should not be limited by these embodiments. According to the present technology, any of the following embodiments and modifications thereof may be combined.

In the following description of the embodiments, the terms with “substantially” such as substantially parallel and substantially orthogonal may be used to describe configurations. For example, being substantially parallel refers to not only an exactly parallel state but also a substantially parallel state which may include a deviation of for example a few percent from the exactly parallel state. The same applies to other expressions with the term “substantially.” The drawings are schematic and are not necessarily drawn to scale.

In the drawings, unless otherwise specified, “up” means the upward direction or the upper side in the drawing, “down” means the downward direction or the lower side in the drawing, “left” means the leftward direction or the left side in the drawing, and “right” means the rightward direction or the right side in the drawing. Also, the same reference characters denote the same or equivalent elements or members in the drawings, and their descriptions will not be repeated.

The description will be given in the following order.
1. First Embodiment (Example 1 of Light Guide Plate)
2. Second Embodiment (Example 2 of Light Guide Plate)
3. Third Embodiment (Example 3 of Light Guide Plate)
4. Fourth Embodiment (Example 4 of Light Guide Plate)
5. Fifth Embodiment (Example 5 of Light Guide Plate)
6. Sixth Embodiment (Example 6 of Light Guide Plate)
7. Seventh Embodiment (Example 7 of Light Guide Plate)
8. Eighth Embodiment (Example 8 of Light Guide Plate)
9. Ninth Embodiment (Example 9 of Light Guide Plate)
10. Tenth Embodiment (Example 10 of Light Guide Plate)
11. Eleventh Embodiment (Example of Image Display Device)

### 1. First Embodiment (Example 1 of Light Guide Plate)

Conventional light guide plates suffer from light leakage from the edges, which reduces light use efficiency. In order to solve the problem, according to the present technology, provided is a light guide plate including an incident part configured to diffract incident light into the light guide plate, a path configured to guide the light diffracted into the light guide plate by the incident part by internal total reflection; and an output part configured to diffract the light guided by the path and output the light toward an observer's pupil, the output part has a plurality of diffraction grating groups in a two-dimensional arrangement, and the plurality of diffraction grating groups includes, in front view, at least one of a diffraction grating configured to diffract the light outward from the output part, a diffraction grating configured to diffract the light inwardly with respect to the output part, and a diffraction grating configured to diffract the light toward the observer's pupil.

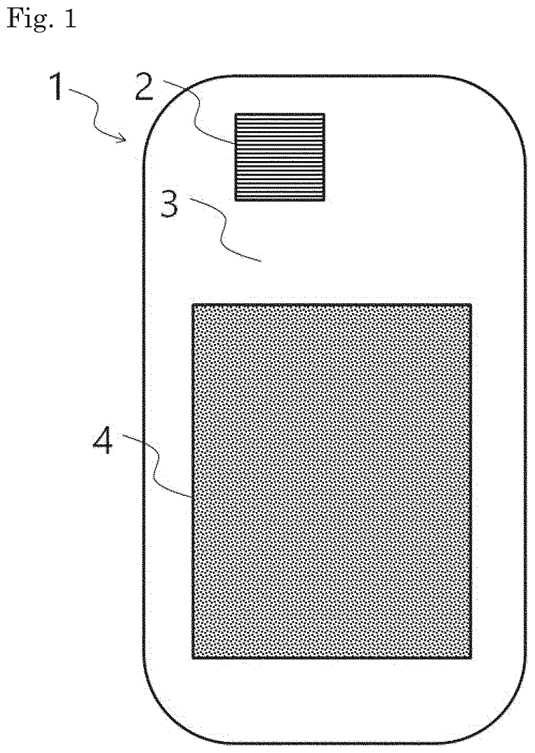

A light guide plate according to an embodiment of the present technology will be described with reference to FIG. 1. FIG. 1 is a simplified front view of an exemplary configuration of a light guide plate 1 according to an embodiment of the present technology. As shown in FIG. 1, the light guide plate 1 according to an embodiment of the present technology has an incident part 2 that diffracts incoming light into the light guide plate 1, a path 3 that guides light diffracted into the light guide plate 1 by the incident part 2 by total internal reflection, and an output part 4 that diffracts light guided by the path 3 and outputs the light toward the observer's pupil. For example, a Surface Relief Grating (SRG), and a Volume Phase Holographic Grating (VPHG) can be used as the incident part 2 and the output part 4.

In the following description, a Surface Relief Grating (SRG) will be described as the incident part 2 and the output part 4 by way of illustration.

Incoming light for example from an image forming part (not shown) that forms image light is diffracted into the light guide plate 1 by the incident part 2. The light diffracted into the light guide plate 1 is totally reflected by the path 3 in the light guide plate 1 and guided to the output part 4. The output part 4 expands outward or returns inwardly the light guided thereto or emits the light into the observer's pupil.

The path 3 to which the light is guided is provided between the incident part 2 and the output part 4 but the incident part 2 and the output part 4 may not necessarily be apart from each other, which will be described below.

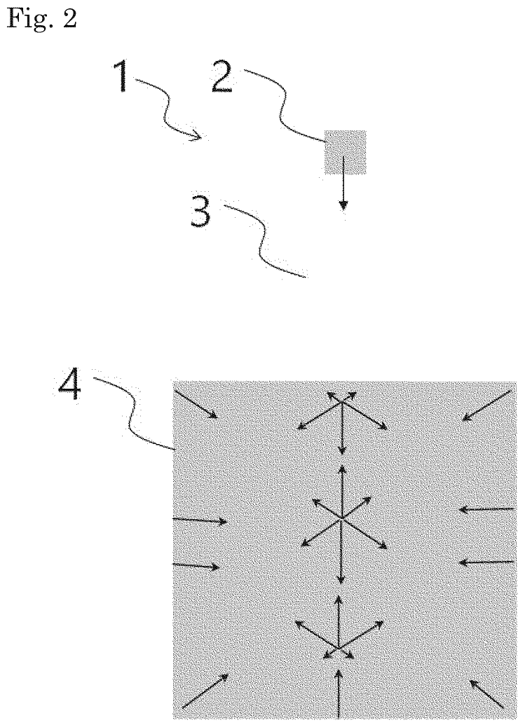

The lattice vectors of the diffraction gratings of the incident part 2 and the output part 4 will be described with reference to FIG. 2. FIG. 2 is a concept diagram for illustrating examples of the lattice vectors of diffraction gratings of the incident part 2 and the output part 4 according to an embodiment of the present technology. As shown in FIG. 2, the diffraction grating provided in the incident part 2 diffracts the incoming light toward the output part 4.

The diffraction gratings located on the inner side of the output part 4 diffract light outward from the output part 4 in front view, thereby spreading the light. The diffraction gratings located on the outer side of the output part 4 diffract light toward the inner side of the output part 4, thereby improving the light use efficiency.

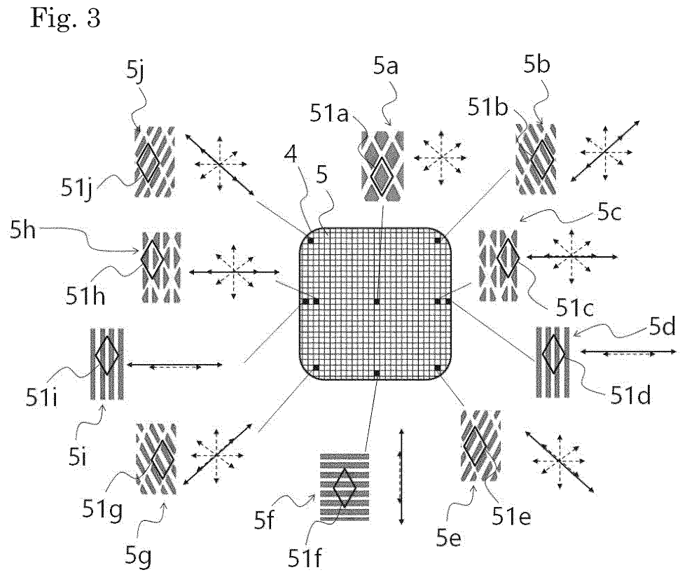

An exemplary configuration of the output part 4 will be described with reference to FIG. 3. FIG. 3 is a simplified front view of an exemplary configuration of the output part 4 according to the embodiment of the present technology. As shown in FIG. 3, the output part 4 has a plurality of diffraction grating groups 5 in a two-dimensional arrangement. The plurality of diffraction grating groups 5 each include at least one of a diffraction grating that diffracts light outward from the output part, a diffraction grating that diffracts light inwardly with respect to the output part, and a diffraction grating that diffracts light toward an observer's pupil. The diffraction grating diffracts light in the two-dimensional direction.

The diffraction grating groups 5 each have a plurality of unit diffraction gratings 51 in a two-dimensional arrangement. The unit diffraction grating 51 is constructed on the basis of a basic vector, which is the minimum lattice vector necessary for light to be output.

The shape of the unit diffraction grating 51 differs according to the position in the plane of the output part 4. In particular, the shape is designed so that the efficiency with respect to the diffraction order is appropriate. By varying the shape of the unit diffraction grating 51, the ratio of the size of the lattice vector that diffracts light in the vertical and horizontal directions to the size of the lattice vector that diffracts light toward the observer's pupil can be varied. For example, the pitch is designed so that the lattice vector is an integer multiple of the basic vector. The pitch refers to the interval in the periodic structure of the diffraction grating (for example between slits).

For example, the diffraction grating group 5a, which is located about in the center of the output part 4, has a diffraction order that diffracts light in a two-dimensional direction (upward, downward, leftward, or rightward) or toward the observer's pupil. The diffraction grating group 5a has a plurality of unit diffraction gratings 51a in a two-dimensional arrangement.

The diffraction grating group 5b, which is arranged on the upper right side of the output part 4, has a diffraction order that diffracts light in the lower left direction or toward the observer's pupil. The pitch of the unit diffraction grating 51b of the diffraction grating group 5b in the lower left direction can be, for example, about half the pitch of the diffraction grating group 5a, which is located about in the center. As a result, the diffraction grating group 5b arranged in the upper right position can act as a sum on the wavenumber of the incoming light and diffract the light in the direction of returning the light (for example in the lower left direction) with the lattice vectors having a lattice vector size that is roughly twice the size of the basic vector. Note that the size of the lattice vector is not limited to about twice and can be at least about three times as large. The same applies to the following description.

Here, the diffraction grating group 5 includes a return diffraction grating that diffracts the light inwardly with respect to the output part 4. In other words, the diffraction grating group 5 located on the upper right side of the output part 4 includes a return diffraction grating. The pitch of the return gratings is the value obtained by dividing the pitch of the other gratings in the output part 4 by an integer.

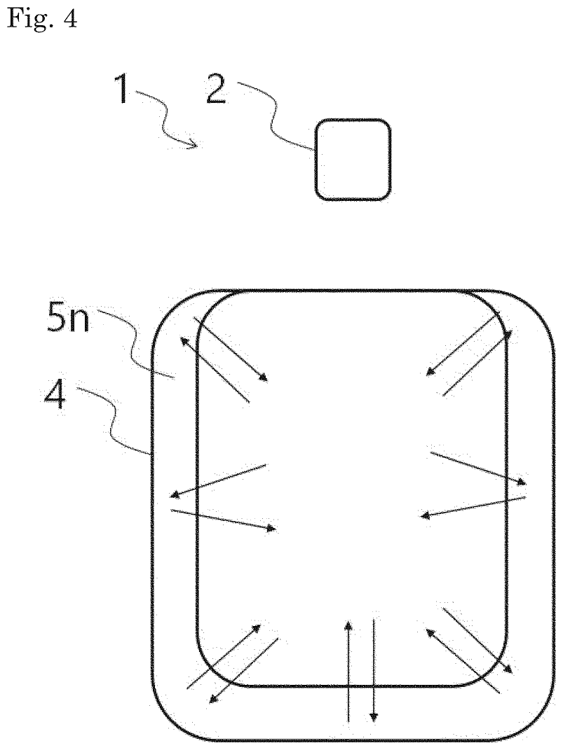

The diffraction grating group 5 including the return diffraction grating is arranged outside of the area where the light from the path 3 is incident and around the outer periphery of the output part 4. This will be described with reference to FIG. 4. FIG. 4 is a simplified front view of an exemplary configuration of the incident part 2 and the output part 4 according to the embodiment of the present technology. As shown in FIG. 4, a diffraction grating group 5n including a return diffraction grating is arranged outside of the area which light from the path 3 enters and in the outer periphery of the output part 4. In this way, the light is diffracted inwardly with respect to the output part 4. As a result, the use efficiency of light is improved.

The arrows show examples of the lattice vectors of the diffraction gratings of the diffraction grating group 5n. The return gratings do not have to return light in the direction exactly opposite to the traveling direction of the incident light. For example, the diffraction grating group 5n, which is located on the right side and about in the center, can diffract light traveling from the upper left about in the lower left direction.

Referring back to FIG. 3, the diffraction grating group 5c, which is located on the right side of the output part 4, also includes a return diffraction grating. The diffraction grating group 5c has a diffraction order that diffracts light to the left or toward the observer's pupil. The pitch of the unit diffraction gratings 51c of the diffraction grating group 5c in the left-right direction can be, for example, about half the pitch of the diffraction grating group 5a, which is arranged in an approximate center. In this way, the diffraction grating group 5c on the right side can diffract light in the direction of returning the light (e.g., to the left) with a lattice vector size that is roughly twice that of the basic vector.

The diffraction grating group 5d, which is located to the right of the diffraction grating group 5c, i.e., at the rightmost part of the output part 4, also includes a return diffraction grating. The diffraction grating group 5d has a diffraction order that diffracts light in the leftward direction. The pitch of the unit diffraction gratings 51 of the diffraction grating group 5d in the left-right direction can be, for example, about half the pitch of the diffraction grating group 5a, which is arranged about in the center. As a result, the diffraction grating group 5d located at the rightmost end can diffract light in the direction of returning the light (e.g., to the left) with a lattice vector size that is roughly twice that of the basic vector. Furthermore, the return gratings included in the diffraction grating group 5 have a stripe-like periodic structure in the up-down direction. This makes the lattice vectors align in one direction, prioritizing the action of diffracting the light in the direction of returning the light.

The diffraction grating group 5e provided on the lower right side of the output part 4 also includes a return diffraction grating. The diffraction grating group 5e has a diffraction order that diffracts light in the direction of returning the light (e.g., to the upper left) or toward the observer's pupil. When vertically inverted, the diffraction grating group 5e has the same configuration as the diffraction grating group 5b provided on the upper right side of the output part 4. Therefore, a detailed description of the diffraction grating group 5e will not be provided.

The diffraction grating group 5f provided at the lowermost end of the output part 4 also includes a return diffraction grating. The diffraction grating group 5f has a diffraction order that diffracts the light in the direction of returning the light (e.g., upward). The diffraction grating group 5f is a configuration obtained by rotating by 90 degrees the diffraction grating group 5d, which is located at the rightmost end of the output part 4. Therefore, a detailed description of the diffraction grating group 5f will not be provided.

The diffraction grating group 5g, which is located on the lower left side of the output part 4, also includes a return diffraction grating. The diffraction grating group 5g has a diffraction order that diffracts light in the direction of returning the light (e.g., upper right) toward the observer's pupil. When inverted horizontally, the diffraction grating group 5g has the same configuration as the diffraction grating group 5e, which is located on the lower right side of the output part 4. Therefore, a detailed description of the diffraction grating group 5e will not be provided.

The diffraction grating group 5h, which is located on the left side of the output part 4, also includes a return diffraction grating. The diffraction grating group 5h has a diffraction order that diffracts light in the direction of returning the light (e.g., to the right) or toward the observer's pupil. When inverted horizontally, the diffraction grating group 5h has the same configuration as the diffraction grating group 5c, which is located on the right side of the output part 4. Therefore, a detailed description of the diffraction grating group 5h will not be provided.

The diffraction grating group 5 i, which is located to the left of the diffraction grating group 5h, i.e., at the leftmost part of the output part 4, also includes a return diffraction grating. The diffraction grating group 5i has a diffraction order that diffracts light in the direction of returning the light (e.g., to the right). When inverted horizontally, the diffraction grating group 5i has the same configuration as the diffraction grating group 5d located at the rightmost part of the output part 4. Therefore, a detailed description of the diffraction grating group 5 will not be provided.

The diffraction grating group 5j, which is located on the upper left side of the output part 4, also includes a return diffraction grating. The diffraction grating group 5j has a diffraction order that diffracts light in the direction of returning the light (e.g., lower right) or toward the observer's pupil. When inverted horizontally, the diffraction grating group 5j has the same configuration as the diffraction grating group 5b, which is located on the upper right side of the output part 4. Therefore, a detailed description of the diffraction grating group 5j will not be provided.

The configuration of the output part 4 allows light to be guided to an appropriate region. This also allows light toward the outside of the output part 4 to be diffracted toward the inside of the output part 4, so that the light can be confined to an appropriate area of the output part 4 for use. As a result, the light use efficiency improves, good luminance distribution can be obtained, and image quality can be improved. Note that these advantageous effects are similarly provided according to other embodiments which will be described. For this reason, the descriptions of these effects may not be repeated in some cases.

The shape of the unit diffraction gratings 51 (51a to 51j) of the diffraction grating groups 5 (5a to 5j) change substantially continuously from one side to the other in the plane of the output part 4. This prevents abrupt changes in the direction of the diffracting lattice vectors. As a result, wavefront turbulence is less likely to occur, and the image quality degradation can be reduced. The wording “changing substantially continuously” may refer to stepwise change of the unit diffraction grating 51. The shape of at least one unit diffraction grating 51 needs only change substantially continuously from one side to the other in the plane of the output part 4.

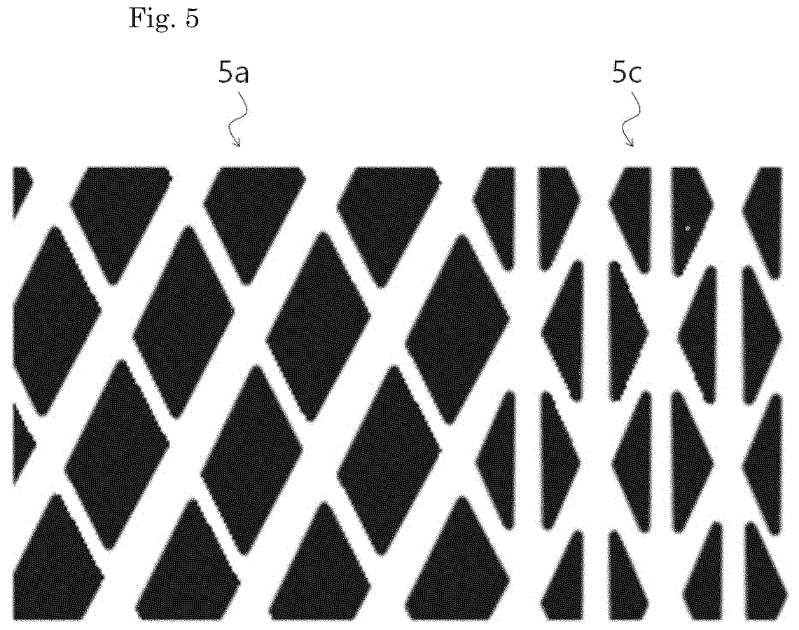

In addition, the diffraction grating groups that are arranged adjacent to each other have lattice vectors substantially in the same direction. This will be described further with reference to FIG. 5. FIG. 5 is a simplified front view of an exemplary configuration of the output part 4 according to the embodiment of the present technology. FIG. 5 shows a diffraction grating group 5a (see FIG. 3) about in the center of the output part 4 and a diffraction grating group 5c on the right side of the output part 4, arranged adjacent to each other by way of illustration. As shown in FIGS. 3 and 5, the diffraction grating groups arranged adjacent to each other have lattice vectors substantially in the same direction. More specifically, at least one of the directions of the lattice vectors of the diffraction gratings of the diffraction grating group 5a arranged about in the center of the output part 4 is substantially the same as the direction of the diffraction gratings of the diffraction grating group 5c provided on the right side of the output part 4. This allows wavefront turbulence to be suppressed even when light hits a plurality of adjacent grating groups. In addition, since the directions of the lattice vectors are substantially the same, there is no need to provide a space between the diffraction grating groups. This can contribute to reduction in the size of the light guide plate 1.

Here, the conventional technology and the present technology will be compared and described. For example, PTL 1 (WO 2020/217044) proposes a light guide plate in which a diffraction grating that diffracts light toward the outside of the light guide plate to the inside of the light guide plate is arranged adjacent to a diffraction grating that diffracts light to the observer's pupil in order to use light efficiently.

Conventionally, the diffraction gratings that diffract light to the inside of the light guide plate and the diffraction gratings that diffract light toward the observer's pupil generally have different orientations for the periodic structures that are formed. Therefore, when light enters the light guide plate at various angles, and the spacing between the diffraction gratings that diffract light to the inside of the light guide plate and those that diffract light toward the observer's pupil is insufficient, the directions of the lattice vectors of the gratings change discretely, and the wavefront can be disturbed at the boundary therebetween, which may cause a degradation in the image quality (especially in terms of MTF).

One measure to solve the problem is to ensure a sufficient distance between the diffraction gratings that diffract light to the inside of the light guide plate and those that diffract light toward the observer's pupil. However, this increases the physical size of the light guide plate. Another problem is that end faces of actual diffraction gratings may have wavefront turbulence due to shape errors and surface turbulence at the periphery, resulting in degraded image quality. In addition, the area with diffraction gratings may look tinted according to the angle from which the observer views the area. This can cause a sense of discomfort when using the product.

Meanwhile, according to the present technology, a diffraction grating group that diffracts light, which is mainly directed outward from the output part 4, inwardly with respect to the output part 4 and a diffraction grating group that diffracts light mainly toward the observer's pupil are arranged adjacent to each other. The diffraction grating groups arranged adjacent to each other have lattice vectors substantially in the same direction. As a result, even light hits a plurality of adjacent grating groups, wavefront turbulence can be reduced. In addition, since the directions of the lattice vectors are substantially the same, there is no need to secure a space between the lattice groups. This contributes to reduction in the size of the light guide plate.

PTL 2 (U.S. Patent Application Publication No. 2021/0072534 (Description)) in dictates that the luminance distribution is improved by appropriately changing the diffraction efficiency by dividing the surface of the surface relief grating into multiple regions. In particular, the uniformity is improved by providing a region without diffraction gratings. However, the presence of the diffraction grating-free region results in many diffraction grating edges existing in the plane, which inevitably degrades the image quality. In addition, because such diffraction gratings are visible and thus degrade the appearance, the gratings are not used as diffraction gratings that diffract light toward the observer's pupil but tend to be used for optical elements that diffract and spread light incident on these diffraction gratings. When these optical elements are separated from the diffraction gratings that diffract the light toward the observer's pupil, the size of the light guide plate increases, which compromises the design integrity.

Meanwhile, according to the present technology, the light use efficiency in the plane of the output part 4 is appropriately designed, and the shape of the unit diffraction grating changes substantially continuously from one side to the other side of the plane of the output part. This avoids deterioration of the appearance. Furthermore, since abrupt changes in the direction of the diffracting lattice vectors are prevented, wavefront turbulence is less likely to occur, so that degradation of image quality is reduced.

In PTL 3 (U.S. Patent Application Publication No. 2021/0209630 (Description)), diffraction gratings are repeatedly arranged in the plane of the diffraction gratings that diffract light toward the observer's pupil, while varying the diffraction efficiency and considering the wave number. For example, in order to distribute the lattice vectors in three directions in the plane, a one-dimensional diffraction grating is divided into detailed regions in the plane and provided. This allows light to be used in the three directions while still maintaining the efficiency of the one-dimensional diffraction grating. However, at the boundaries between the regions, the directions of the wavefronts are different, and the directions of the lattice vectors change discretely, which causes the wavefronts of light hitting both gratings to become distorted. The presence of many such boundary lines are attributable to degraded image quality.

Furthermore, PTL 3 proposes to continuously change the shape of diffraction gratings without causing abrupt changes in lattice vectors, in consideration of the pitch of the diffraction gratings. However, since the shape is continuously changed in a one-dimensional direction, flexibility in designing the diffraction efficiency is low. Therefore, it is difficult to diffract light, which is directed outward from the light guide plate, in the appropriate direction.

Meanwhile, according to the technology, the diffraction order and the efficiency distribution can be designed more flexibly because the diffraction grating groups are two-dimensionally arranged. Since abrupt changes in the direction of the diffracting lattice vectors are prevented, wavefront turbulence is less likely to occur, and image quality degradation can be reduced. Furthermore, a group of diffraction gratings that diffract with a lattice vector size that is an integer multiple of a basic vector are arranged by adjusting the pitch, light directed outward from the output part 4 can be diffracted to the inside of the output part 4. As a result, the light use efficiency is improved.

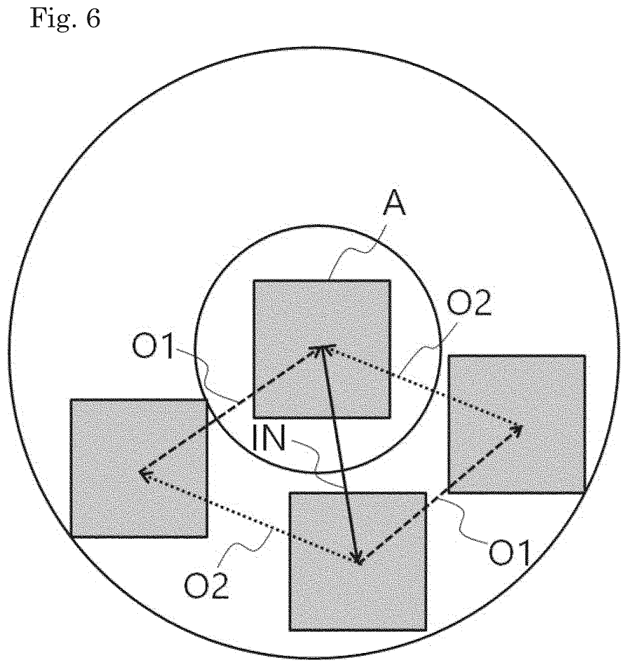

An exemplary design of a diffraction grating according to the embodiment of the present technology will be described with reference to FIG. 6. FIG. 6 indicates wavenumber space coordinates for depicting an exemplary design of a diffraction grating according to the embodiment of the present technology. FIG. 6 shows the lattice vectors IN, O1, O2, and the angle-of-view area A are shown.

The lattice vector IN indicates the lattice vector of the diffraction grating of the incident part 2 for capturing incident light into the light guide plate 1. The lattice vectors O1 and O2 indicate the lattice vectors of the diffraction gratings of the output part 4 for spreading light which has been taken into the light guide plate 1 outward or outputting the light toward the observer's pupil.

In this design example, the lattice vectors IN, O1, and O2 forms a substantially equilateral triangle. The sum of the lattice vector IN of the incident part 2 and the basic lattice vectors O1 and O2 of the output part 4 is zero and closed. This prevents degradation of image quality. If the difference is not closed and increases, the image quality is more degraded.

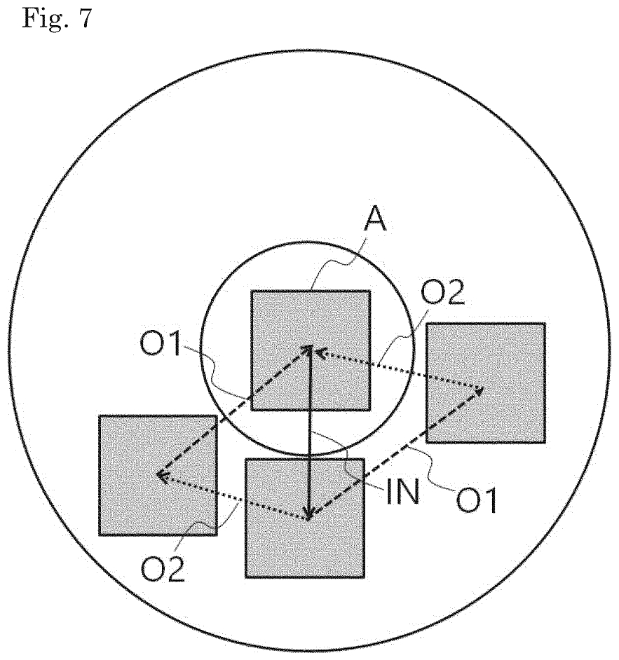

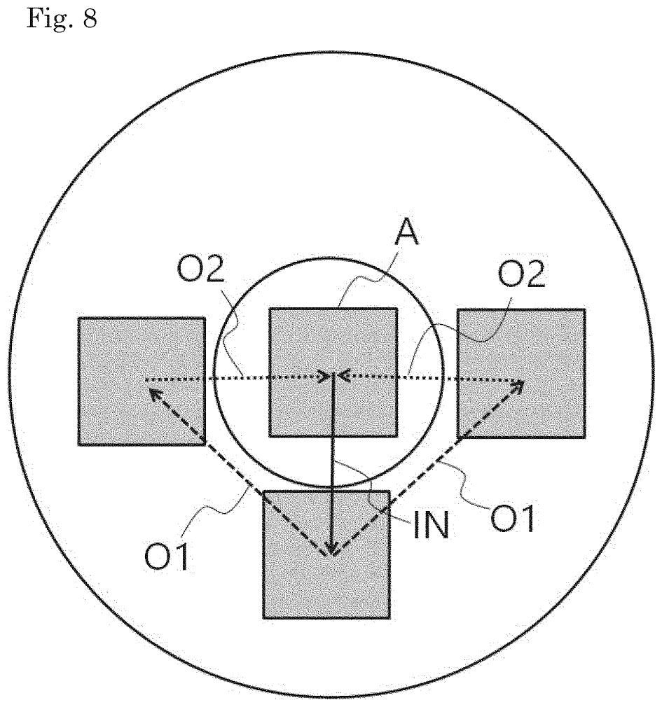

The design of the diffraction grating according to the embodiment of the present technology is not limited to the above example. Other design examples of diffraction gratings according to the embodiment of the present technology will be described with reference to FIGS. 7 and 8. FIGS. 7 and 8 indicate wavenumber space coordinates for depicting examples of diffraction grating designs according to the embodiment of the present technology. As shown in FIGS. 7 and 8, the lattice vectors can be designed while flexibly changing their lengths and directions. In these design examples, the sum of the lattice vector IN of the incident part 2 and the basic lattice vectors O1 and O2 of the output part 4 is zero and closed. This prevents degradation of image quality.

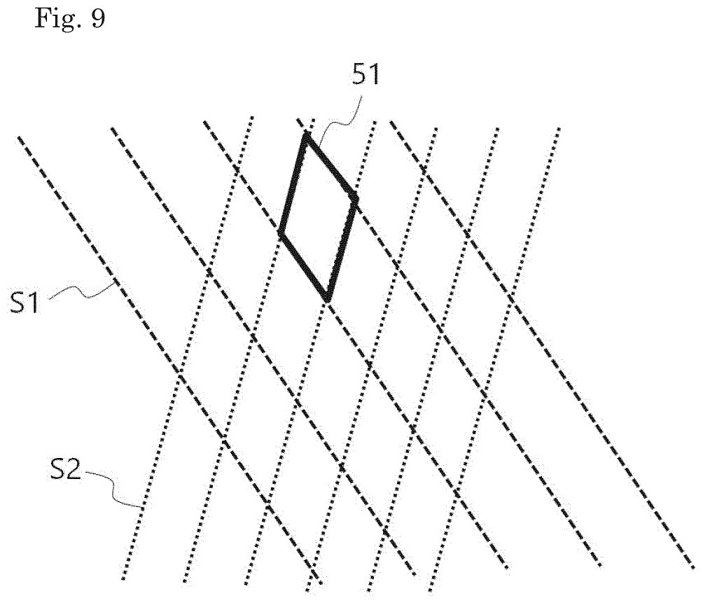

The unit diffraction grating 51 includes a combination of periodic structures of gratings of the output part 4. This will be described with reference to FIG. 9. FIG. 9 is a simplified plan view of an exemplary configuration of a unit diffraction grating according to the embodiment of the present technology. FIG. 9 illustrates a periodic structure S1 of the diffraction grating including the lattice vector O1 and a periodic structure S2 of the diffraction grating including the lattice vector O2.

The combination of the periodic structure S1 of the diffraction gratings and the periodic structure S2 of the diffraction gratings is configured as the unit diffraction grating 51. The shape of the unit diffraction grating 51 varies according to the direction and pitch of the lattice vector to be obtained.

For example, at a wavelength of 530 nm of green light, if the lattice vectors IN, O1, and O2 constitute a substantially equilateral triangle and the refractive index of the light guide plate 1 is about 2.0, the pitch can be formed to be 360 nm. The pitch may vary according to the refractive indices of the materials of the light guide plate and the diffraction gratings. For example, when using light with a short wavelength such as blue light, the pitch is short, and when using light with a long wavelength such as red light, the pitch is long.

As shown in FIG. 3, the shape of the unit diffraction grating 51 changes according to the position of the diffraction grating group. By changing the shape of the diffraction grating, the diffraction efficiency distribution in the plane of the output part 4 can be flexibly designed and varied. This improves the light use efficiency and provides a smooth luminance distribution.

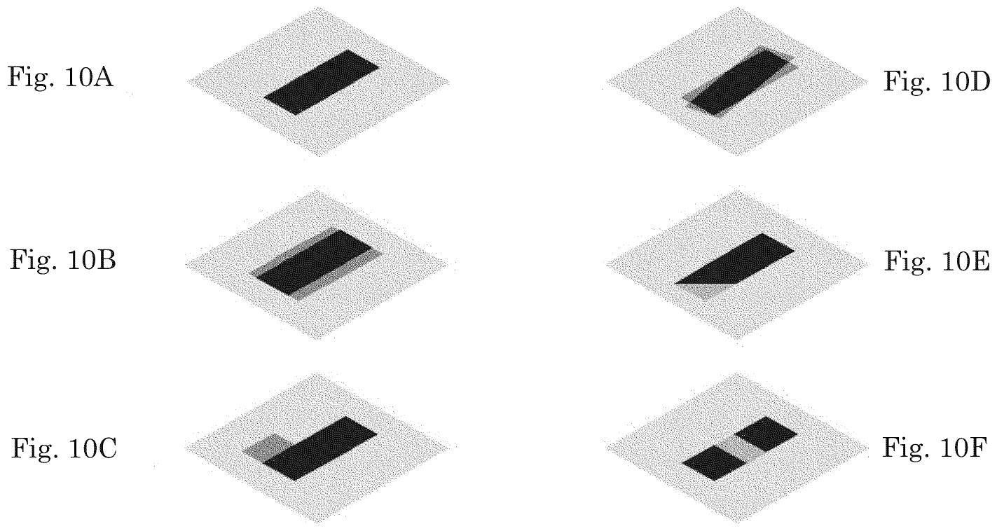

An example of the shape of the unit diffraction grating 51 will be described with reference to FIG. 10. FIG. 10 is a simplified perspective view of examples of the shape of a diffraction grating that constitutes a unit diffraction grating 51 according to the embodiment of the present technology.

FIG. 10A shows an example of a basic diffraction grating shape.

FIG. 10B shows an example of the shape when the width of the basic diffraction grating shown in FIG. 10A is changed. The length of the width is not limited to that in the figure.

FIG. 10C shows an example of the shape when the basic diffraction grating shown in FIG. 10A has a protrusion. The position and size of the protrusion are not limited to those in the figure.

FIG. 10D shows an example of the shape when the basic diffraction grating shown in FIG. 10A is rotated in the plane of the output part 4. The angle and direction of rotation are not limited to those in the figure.

FIG. 10E shows an example of the shape when the basic diffraction grating shown in FIG. 10A has a part removed. The position and size of the part to be removed is not limited to those in the figure.

FIG. 10F shows an example of the shape when the basic diffraction grating shown in FIG. 10A is divided. In this way, a new diffraction grating period can be added, and the pitch can be divided by an integer. More specifically, the size of the lattice vector can be multiplied by the integer. The position of the division does not have to be about in the center as shown. For example, similarly to the configuration realized in the meta surface, the size of the lattice vector does not have to be an integer multiple.

For example, the diffraction grating may have a shape at least partly curved.

Furthermore, the diffraction grating may be designed into a shape that changes with respect to the direction of the height from the plane of the output part 4. For example, the diffraction grating may have multiple heights or may be formed into a stepwise or tapered shape.

The shape of the diffraction grating that constitutes the unit diffraction grating 51 is not limited to the above. Any of the shapes described above can also be combined.

The diffraction grating that constitutes the unit diffraction grating 51 may be coated with a resin with a high refractive index. By coating with resins with different refractive indices, the diffraction efficiency can be varied.

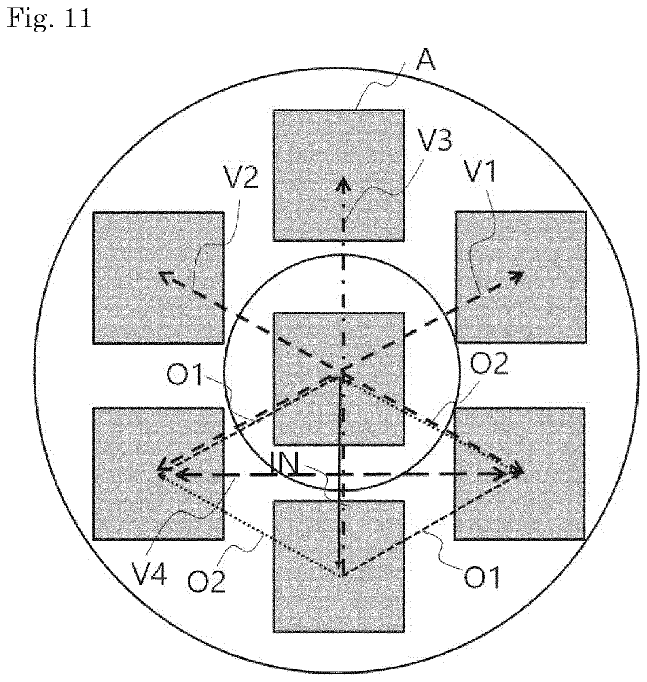

A design example of a diffraction grating according to the embodiment of the present technology will be described with reference to FIG. 11. FIG. 11 indicates wavenumber space coordinates for depicting an exemplary design of the diffraction grating according to the embodiment of the present technology.

The lattice vector V1 is the lattice vector of diffraction gratings of the diffraction grating group 5b (see FIG. 3), which is located at the upper right end of the output part 4 or the diffraction grating group 5g, which is located at the lower left end. The diffraction grating has a lattice vector length that is approximately twice the basic lattice vectors O1 and O2 and can diffract light inwardly with respect to the output part 4.

The lattice vector V2 is the lattice vector of the diffraction gratings of the diffraction grating group 5j, which is located at the upper left end of the output part 4 or the diffraction grating group 5e, which is located at the lower right end. These diffraction gratings have a lattice vector length that is approximately twice the length of the basic lattice vectors O1 and O2 and can diffract light inwardly with respect to the output part 4.

The lattice vector V3 indicates the lattice vector of the diffraction gratings of the diffraction grating group 5f, which is located in an approximate center at the lower end of the output part 4. The diffraction grating has a lattice vector length that is approximately twice the length of the basic lattice vectors O1 and O2 and can diffract light inwardly with respect to the output part 4.

The lattice vector V4 indicates the lattice vector of the diffraction gratings of the diffraction grating group 5i which is located in an approximate center at the left end of the output part 4 or the diffraction grating group 5d, which is located in an approximate center at the right end of the output part 4. The diffraction gratings have a lattice vector length that is equal to the sum of the basic lattice vector O1 and the basic lattice vector O2 and can diffract light inwardly with respect to the output part 4.

The above description of the light guide plate according to the first embodiment of the present technology can be applied to other embodiments of the technology unless there is any particular technical contradiction.

### 2. Second Embodiment (Example 2 of Light Guide Plate)

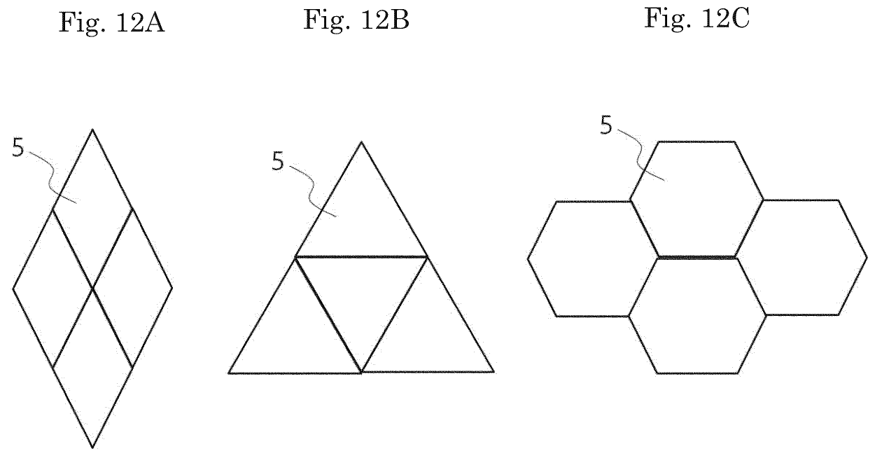

The shape of the diffraction grating group 5 is not limited to the regular square as shown in FIG. 3. This will be described with reference to FIG. 12. FIG. 12 is a simplified front view of an exemplary configuration of the diffraction grating group 5 according to an embodiment of the present technology.

As shown in FIG. 12A, the diffraction grating group 5 may have a rhombic shape. As shown in FIG. 12B, the diffraction grating group 5 may have a triangular shape. As shown in FIG. 12C, the diffraction grating group 5 may have a hexagonal shape. In addition, the diffraction grating group 5 may have a polygonal shape such as a pentagon, a polygon with rounded corners, a circle, and an oval.

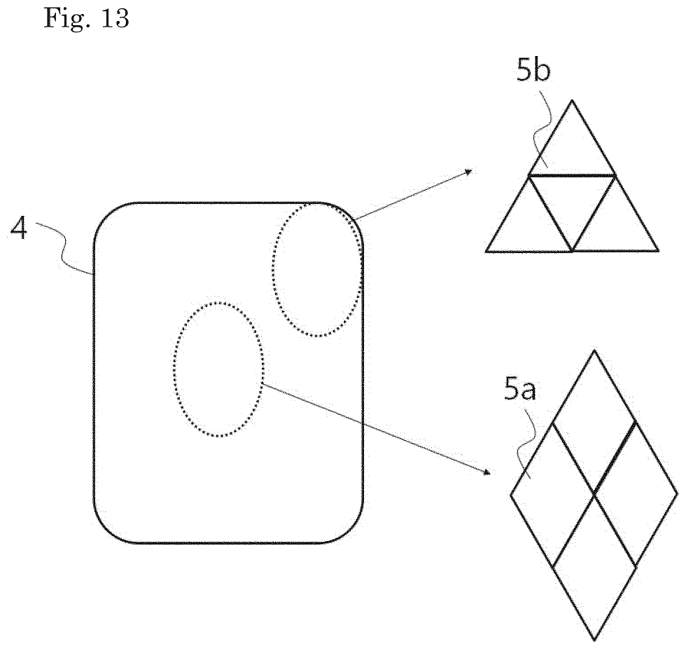

The shape of the diffraction grating group 5 may be different according to the position in the plane of the output part. This will be described with reference to FIG. 13. FIG. 13 is a simplified front view of an exemplary configuration of the diffraction grating group 5 according to the embodiment of the present technology. As shown in FIG. 13, the diffraction grating group 5a, which is arranged about in the center of the output part 4, has a rhombic shape. The diffraction grating group 5b on the upper right side of the output part 4 has a triangular shape. The area of the diffraction grating group 5 on the upper right side of the output part 4 is half that of the diffraction grating group 5 about in the center of the output part 4. As a result, the diffraction grating group 5 on the upper right side of the output part 4 can diffract light more precisely.

The above description of the light guide plate according to the second embodiment of the present technology can be applied to other embodiments of the technology unless there is any particular technical contradiction.

### 3. Third Embodiment (Example 3 of Light Guide Plate)

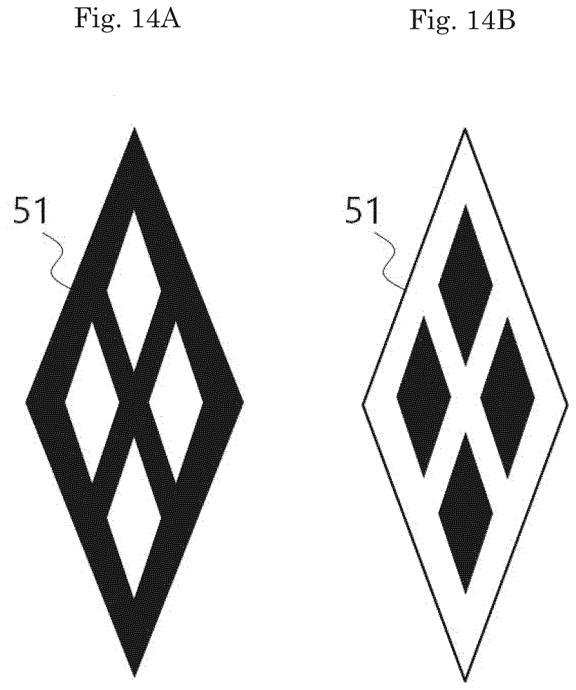

The unit diffraction grating 51 may have a hole pattern or a pillar pattern. This will be described with reference to FIG. 14. FIG. 14 is a simplified plan view of exemplary configurations of the unit diffraction grating 51 according to an embodiment of the present technology.

FIG. 14A shows an exemplary configuration of the unit diffraction grating 51 having a hole pattern. The black-colored area is the part protruding in the foreground. In this figure, four holes are formed.

FIG. 14B shows an example of the unit diffraction grating 51 having a pillar pattern. In the figure, four pillars are formed. The hole pattern and the pillar pattern can be selected according to a required manufacturing cost and diffraction efficiency.

The unit diffraction grating 51 in the hole pattern and the unit diffraction grating 51 in the pillar pattern may be combined to form a unit diffraction grating.

The above description of the light guide plate according to the third embodiment of the present technology can be applied to other embodiments of the technology unless there is any particular technical contradiction.

### 4. Fourth Embodiment (Example 4 of Light Guide Plate)

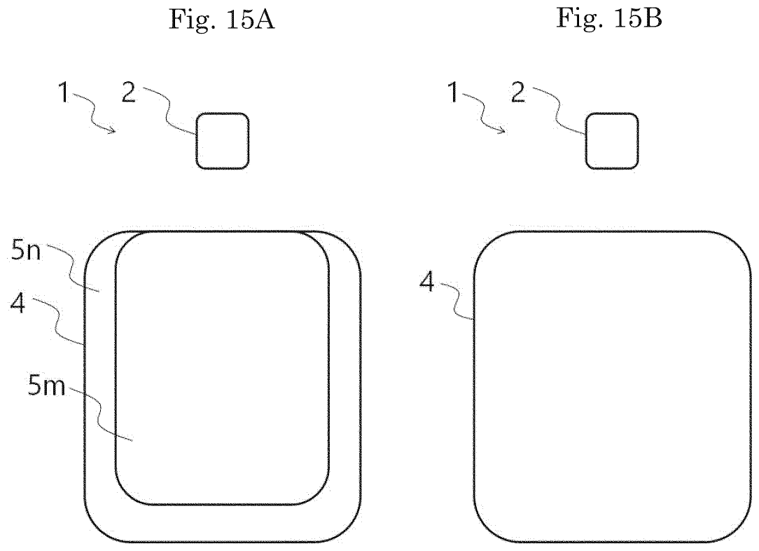

A diffraction grating group 5 that diffracts light in one direction may or may not be arranged at the edge of the output part 4 similarly to the first embodiment. This will be described with reference to FIG. 15. FIG. 15 is a simplified plan view of exemplary configurations of the output part 4 according to an embodiment of the present technology.

In FIG. 15A, similarly to the first embodiment, a diffraction grating group 5n that diffracts light in one direction is arranged at the edge of the output part 4. The diffraction grating group 5n has a periodic structure in a stripe-like shape similarly to the diffraction grating groups 5d, 5f, and 5i in FIG. 3, and the action of diffracting light in one direction is prioritized.

The diffraction grating group 5m arranged on the inner side of the output part 4 diffracts and spreads outward light guided thereto or diffracts the light inwardly to improve the light use efficiency or to emit the light to the observer's pupil according to the position where the diffraction grating group is arranged.

In FIG. 15B, the diffraction grating group 5 which diffracts light in one direction is not arranged at the edge of the output part 4. The diffraction grating groups 5 each diffract and spread light guided thereto outward or diffracts the light inwardly to improve the light use efficiency or emits the light to the observer's pupil according to the position where the diffraction groups are arranged.

The above description of the light guide plate according to the fourth embodiment of the present technology can be applied to other embodiments of the technology unless there is any particular technical contradiction.

### 5. Fifth Embodiment (Example 5 of Light Guide Plate)

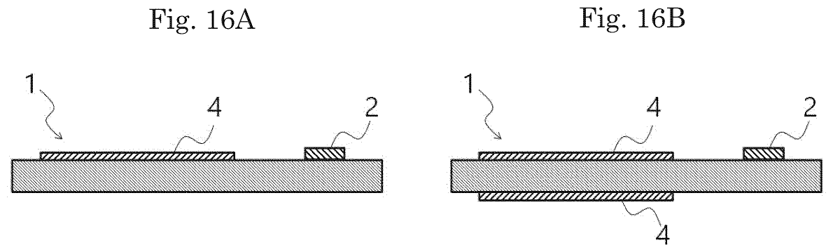

The output part 4 may be arranged on one or both sides of the light guide plate 1. This will be described with reference to FIG. 16. FIG. 16 is a simplified side cross-sectional view of exemplary configurations of the light guide plate 1 according to an embodiment of the present technology.

As shown in FIG. 16A, the output part 4 may be arranged only on one side of the light guide plate 1. This simplifies the manufacturing process and reduces the manufacturing costs.

As shown in FIG. 16B, the output part 4 may be arranged on either side of the light guide plate 1. This allows for more design flexibility. As a result, the light use efficiency and luminance distribution can be improved. For example, the output part 4 on one side may control the direction in which light is guided inside of the light guide plate 1, and the output part 4 on the other side may emit the light toward the observer's pupil.

The positions of the incident part 2 and the output part 4 are not limited to the above. The incident part 2 and the output part 4 may be arranged on the same surface or on different surfaces. Where to position these parts depends on whether a transmission-type diffraction grating or a reflection-type diffraction grating is used.

The above description of the light guide plate according to the fifth embodiment of the present technology can be applied to other embodiments of the technology unless there is any particular technical contradiction.

### 6. Sixth Embodiment (Example 6 of Light Guide Plate)

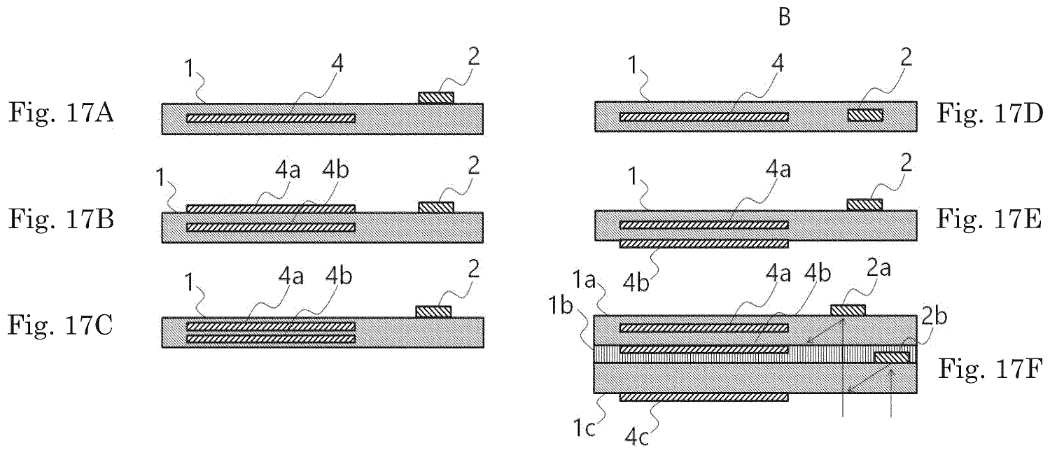

The output part 4 may or may not be arranged in the same location as the incident part 2 in the thickness-wise direction of the light guide plate 1. The light guide plate 1 may have one or more incident parts 2 and one or more output parts 4. This will be described with reference to FIG. 17. FIG. 17 is a simplified side cross-sectional view of exemplary configurations of the light guide plate 1 according to an embodiment of the present technology.

As shown in FIG. 17A, the output part 4 may be arranged on a different surface from the incident part 2. In the exemplary configuration, the output part 4 is arranged inside of the light guide plate 1.

As shown in FIGS. 17B, 17C, and 17E, the light guide plate 1 may include one incident part 2 and a plurality of output parts 4a and 4b. In the exemplary configuration shown in FIG. 17B, the incident part 2 and the output part 4a are arranged on the same surface of the light guide plate 1. The output part 4b is arranged inside of the light guide plate 1. In the exemplary configuration shown in FIG. 17C, the output parts 4a and 4b are arranged inside of the light guide plate 1. In the exemplary configuration shown in FIG. 17E, the output part 4a is located inside of the light guide plate 1, and the output part 4b is located on the surface of the light guide plate 1.

In the exemplary configuration shown in FIG. 17D, the incident part 2 and the output part 4 are arranged inside of the light guide plate 1. The positions of the incident part 2 and the output part 4 in the thickness-wise direction of the light guide plate 1 may be the same or different.

As shown in FIG. 17F, the light guide plate 1 may have a plurality of incident parts 2a and 2b and a plurality of output parts 4a, 4b, and 4c. A plurality of light guide plates 1 may also be provided. In the exemplary configuration, the incident part 2a is arranged on the surface of the light guide plate 1a, and the output part 4a is arranged inside of the light guide plate 1a. The output part 4b and the incident part 2b are arranged inside of the light guide plate 1b. The output part 4c is arranged on the surface of the light guide plate 1c. The light guide plates 1a, 1b, and 1c are arranged in this order and stacked on each other. For example, the light guide plates 1a and 1c can include a material with a high refractive index, and the light guide plate 1b can include a material with a low refractive index. In the exemplary configuration, the light guide plate 1 can emit multiple kinds of light with different wavelengths to the observer's pupil.

As a result, colorization and higher viewing angles are allowed. The positions of the incident parts 2a and 2b in the longitudinal direction of the light guide plate 1 may be the same or different. By arranging the incident parts 2a and 2b in different positions, multiple kinds of light with different wavelengths are incident at different positions. This can reduce the occurrence of crosstalk.

In this way, the output parts 4 may be arranged on the surface of the light guide plate 1 or at various positions in the thickness-wise direction of the light guide plate 1.

Where to position the incident part 2 and the output part 4 and the number of the light guide plates 1, the number the incident parts 2, and the output parts 4 are not limited to those of the above exemplary configurations. The above exemplary configurations can also be combined.

The above description of the light guide plate according to the sixth embodiment of the present technology can be applied to other embodiments of the present technology unless there is any particular technical contradiction.

### 7. Seventh Embodiment (Example 7 of Light Guide Plate)

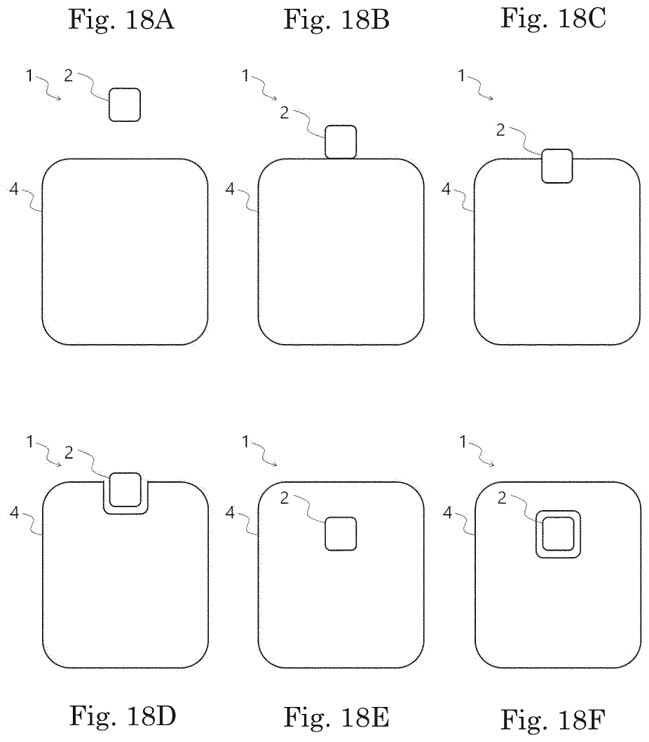

There is no particular limitation on where to position the incident part 2 and the output part 4. This will be described with reference to FIG. 18. FIG. 18 is a simplified front view of exemplary configurations of the incident part 2 and the output part 4 according to an embodiment of the present technology.

As in the exemplary configurations shown in FIGS. 18A, 18D, and 18F, the incident part 2 and the output part 4 may be arranged apart from each other. The incident part 2 may be arranged inside of the output part 4 in some cases.

Alternatively, the incident part 2 and the output part 4 can be arranged in contact with each other, as in the exemplary configurations shown in FIGS. 18B, 18C, and 18E. The incident part 2 can also be arranged inside of the output part 4.

Although not shown, the diffraction grating group 5n that diffracts light in one direction may be further arranged at the edge of the output part 4 as shown in FIG. 4.

The above description of the light guide plate according to the seventh embodiment of the present technology can be applied to other embodiments of the technology unless there is any particular technical contradiction.

### 8. Eighth Embodiment (Example 8 of Light Guide Plate)

A light guide plate provided according to the present technology further includes an extension part between the incident part and the output part, the extension part has a plurality of diffraction grating groups in a two-dimensional arrangement, the plurality of diffraction grating groups include, in a front view, at least one of a diffraction grating that diffracts light outward from the output part, a diffraction grating that diffracts light in the inward direction of the output part, the light guide plate includes at least one of the following: a diffraction grating that diffracts the light in the outward direction of the output part, a diffraction grating that diffracts the light in the inward direction of the output part, and a diffraction grating that diffracts the light in the outward direction of the output part.

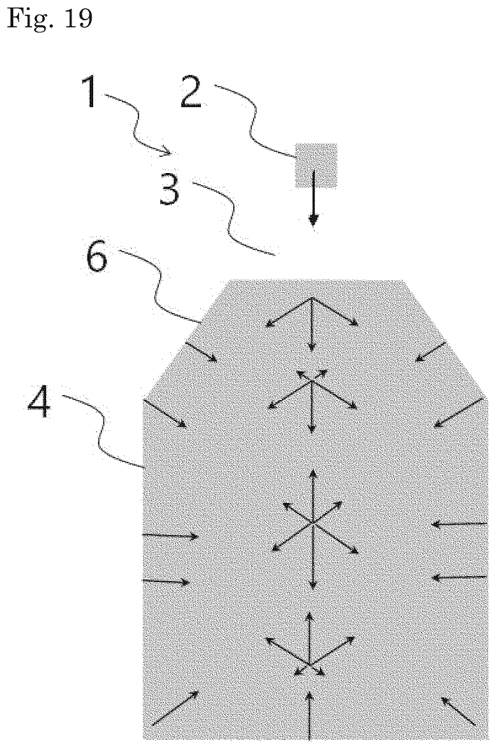

The lattice vectors of the diffraction gratings of the incident part 2, the output part 4, and the extension part 6 will be described with reference to FIG. 19. FIG. 19 is a concept diagram of examples of lattice vectors of diffraction gratings of the incident part 2, the output part 4, and the extension part 6. As shown in FIG. 19, the light guide plate 1 according to the embodiment of the present technology further includes the extension part 6 between the incident part 2 and the output part 4.

The extension part 6 has a plurality of diffraction grating groups in a two-dimensional arrangement. The plurality of diffraction grating groups include, in a front view, at least one of a diffraction grating that diffracts light outward from the output part, a diffraction grating that diffracts light inwardly with respect to the output part, and a diffraction grating that diffracts light toward the output part. This improves the light use efficiency and spreads light incident on the output part 4.

The extension part 6 and the output part 4 are arranged adjacent to each other. This is possible because the diffraction grating groups arranged adjacent to each other have lattice vectors substantially in the same direction. This eliminates the need for a space between the diffraction grating groups. As a result, this contributes to reduction in the size of the light guide plate 1.

Although not shown, similarly to the seventh embodiment, the incident part 2 and the extension part 6 may be arranged apart from each other or in contact with each other.

The above description of the light guide plate according to the eighth embodiment of the present technology can be applied to other embodiments of the present technology unless there is any particular technical contradiction.

### 9. Ninth Embodiment (Example 9 of Light Guide Plate)

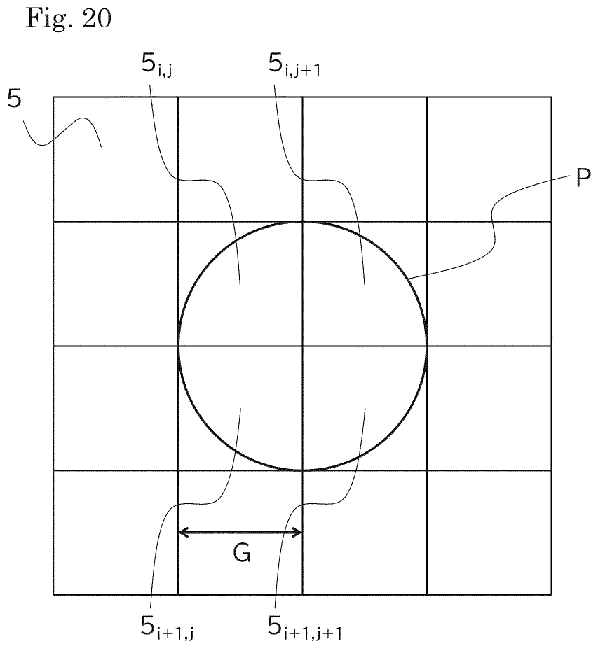

The spacing of the plurality of diffraction grating groups is preferably smaller than the pupil diameter of the observer. This will be described with reference to FIG. 20. FIG. 20 is a simplified front view of an exemplary configuration of the diffraction grating group 5 according to an embodiment of the present technology.

As shown in FIG. 20, the spacing G of the plurality of diffraction grating groups 5 is preferably smaller than the pupil diameter (diameter of the pupil P) of the observer. The pupil diameter varies from person to person and depends on the brightness of the surrounding environment and generally varies from about 2.0 mm to about 8.0 mm. In particular, a pupil diameter of 3.0 mm is generally assumed in the design of light guide plates used for AR. Therefore, when the light guide plate according to the embodiment of the present technology is used for AR, the spacing G of the plurality of diffraction grating groups 5 is preferably 3.0 mm or less. The spacing G of the plurality of diffraction grating groups 5 may be 2.0 mm or less.

The spatial distribution in light at a single angle entering the observer's pupil is not easily perceived by the observer. The observer can recognize the total amount of light and its angular luminance distribution. Therefore, if for example there is irregularity in the spatial distribution equal to or smaller than the pupil diameter, an observer is hardly aware of it. The present technology takes advantage of this characteristic.

In the exemplary configuration shown in FIG. 20, the spacing G of the plurality of diffraction grating groups 5 is a half of the diameter of the observer's pupil. The spacing G of the plurality of diffraction grating groups 5 is preferably a half or less of the pupil diameter of the observer. For example, when a pupil diameter of 3.0 mm is assumed, the spacing G of the plurality of diffraction grating groups 5 is preferably 1.5 mm or less. For example, when a pupil diameter of 2.0 mm is assumed, the spacing G of the plurality of diffraction grating groups 5 is preferably 1.0 mm or less. If the spacing G of the plurality of diffraction grating groups 5 is smaller than the pupil diameter of the observer, the spacing may be about a half or more of the pupil diameter.

The luminance of light emitted by each of the plurality of diffraction grating groups 5 perpendicularly to the plane will be described. Assume that E₀ indicates a target luminance when light from n diffraction grating groups 5 is incident on the pupil P. Assume that E_{i,j} is the luminance of light emitted by the diffraction grating groups 5_{i,j}. The luminance E_{i,j} is calculated using the following expression (1):

$$\begin{matrix}[ Math . 1 ] & \\ {E}_{i , j} = {E}_{0} \pm {Δ}_{i , j} & ( 1 )\end{matrix}$$

In this case, the luminance Eₚᵤₚᵢₗ perceived by the observer can be calculated using the following expression (2):

$$\begin{matrix}[ Math . 2 ] & \\ {E}_{pupil} = \frac{1}{n} {\sum }_{i , j = 1}^{π} ( {E}_{0} \pm {Δ}_{i , j} ) & ( 2 )\end{matrix}$$

As in expression (2), the luminance Eₚᵤₚᵢₗ perceived by the observer is the average of the luminance values of the plurality of diffraction grating groups 5 added together. Therefore, as the spacing G of the plurality of diffraction grating groups 5 decreases, the luminance approaches the target luminance E₀.

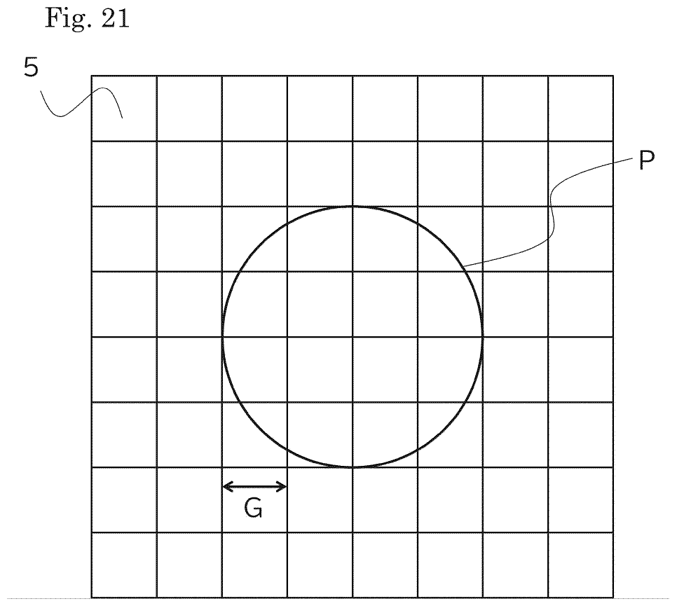

The spacing G of the plurality of diffraction grating groups 5 is more preferably equal to or less than approximately ¼ of the pupil diameter of the observer. This will be described with reference to FIG. 21. FIG. 21 is a simplified front view of an exemplary configuration of the diffraction grating group 5 according to the embodiment of the present technology.

As shown in FIG. 21, the spacing G of the plurality of diffraction grating groups 5 is approximately ¼ of the pupil diameter of the observer. The spacing G of the plurality of diffraction grating groups 5 is preferably at most ¼ of the pupil diameter of the observer. For example, when a pupil diameter of 3.0 mm is assumed, the spacing G of the plurality of diffraction grating groups 5 is preferably 0.75 mm or less. For example, when a pupil diameter of 2.0 mm is assumed, the spacing G of the plurality of diffraction grating groups 5 is preferably 0.5 mm or less.

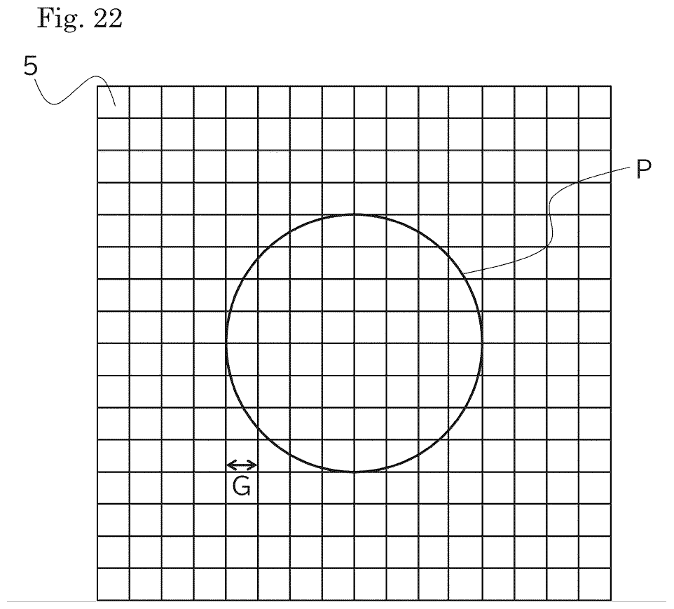

The spacing of the plurality of diffraction grating groups is preferably equal to or less than approximately ⅛ of the pupil diameter of the observer. This will be described with reference to FIG. 22. FIG. 22 is a simplified front view of an exemplary configuration of the diffraction grating group 5 according to the embodiment of the present technology.

As shown in FIG. 22, the spacing G of the plurality of diffraction grating groups 5 is approximately ⅛ of the pupil diameter of the observer. The spacing G of the plurality of diffraction grating groups 5 is preferably at most approximately ⅛ of the pupil diameter of the observer. For example, when a pupil diameter of 3.0 mm is assumed, the spacing G of the plurality of diffraction grating groups 5 is preferably 0.375 mm or less. For example, when a pupil diameter of 2.0 mm is assumed, the spacing G of the plurality of diffraction grating groups 5 is preferably 0.25 mm or less.

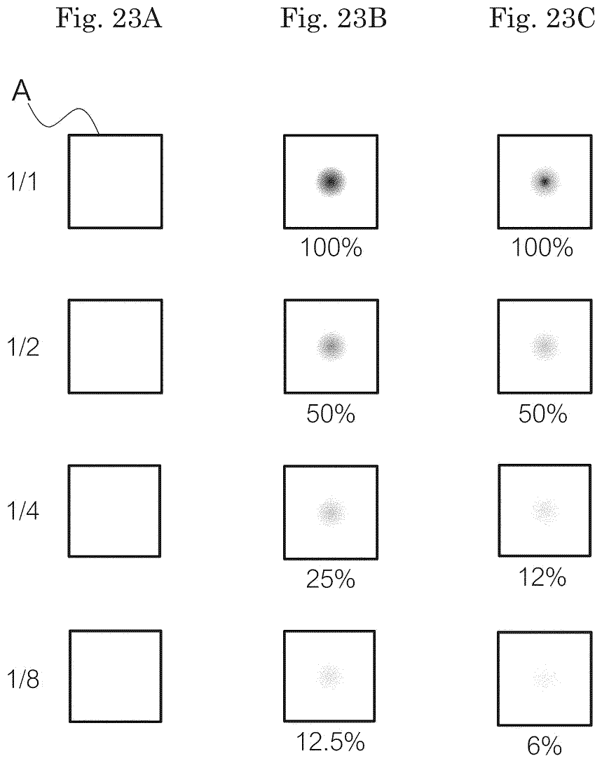

Now, the luminance distribution will be described with reference to FIG. 23. FIG. 23 is a schematic view of examples of luminance distributions in an angle-of-view area A according to the present technology.

FIG. 23A shows an ideal luminance distribution perceived by an observer.

FIG. 23B shows the luminance distribution of light emitted by the diffraction grating group 5 when the luminance of light emitted by the unit diffraction grating located in the vicinity of an approximate center of the angle-of-view area A is zero.

FIG. 23C shows a perceived luminance distribution by an observer, calculated on the basis of the sRGB standard. Details of the sRGB standard will be described below.

FIGS. 23A, 23B, and 23C shows, from the top to the bottom, the luminance distribution and the perceived luminance distribution when the spacing G of the plurality of diffraction grating groups 5 and the pupil diameter are substantially the same (1/1), when the spacing G is approximately a half (½) of the pupil diameter, when the spacing G is approximately a quarter (¼) of the pupil diameter, and when the spacing G is approximately an eighth (⅛) of the pupil diameter.

When the spacing G of the plurality of diffraction grating groups 5 and the pupil diameter are substantially the same (1/1), the luminance distribution shown in FIG. 23B and the perceived luminance distribution shown in FIG. 23C both show a 100% decrease in luminance near the approximate center of the angle-of-view area A. Therefore, the observer can perceive the decrease in luminance.

When the spacing G of the plurality of diffraction grating groups 5 is a half (½) of the pupil diameter, the luminance distribution shown in FIG. 23B shows a 50% decrease in luminance in the vicinity of the approximate center of the angle-of-view area A. In addition, the perceived luminance distribution shown in FIG. 23C shows a 50% decrease in luminance near the approximate center of the angle-of-view area A.

When the spacing G of the plurality of diffraction grating groups 5 is approximately a quarter (¼) of the pupil diameter, the luminance distribution shown in FIG. 23B has a 25% decrease in luminance near the approximate center of the angle-of-view area A. The perceived luminance distribution shown in FIG. 23C shows a 12% decrease in luminance near the approximate center of angle-of-view area A. The decrease in luminance is perceptible but not bothersome, which is a desirable state.

When the spacing G of the plurality of diffraction grating groups 5 is approximately ⅛ of the pupil diameter, the luminance distribution shown in FIG. 23B shows a 12.5% decrease in luminance near the approximate center of the angle-of-view area A. The perceived luminance distribution shown in FIG. 23C shows a 6% decrease in luminance near the approximate center of angle-of-view area A. This is a more desirable condition, since the decrease in luminance is less perceivable.

As in the foregoing, the spacing G of the plurality of diffraction grating groups 5 is preferably about at most a half of the pupil diameter of the observer, more preferably about at most ¼, and about at most ⅛.

Now, the sRGB standard will be briefly described. The sRGB standard is a color space standard used by various devices such as displays, digital cameras, and printers. The sRGB standard is expressed in consideration of human visual sensitivity.

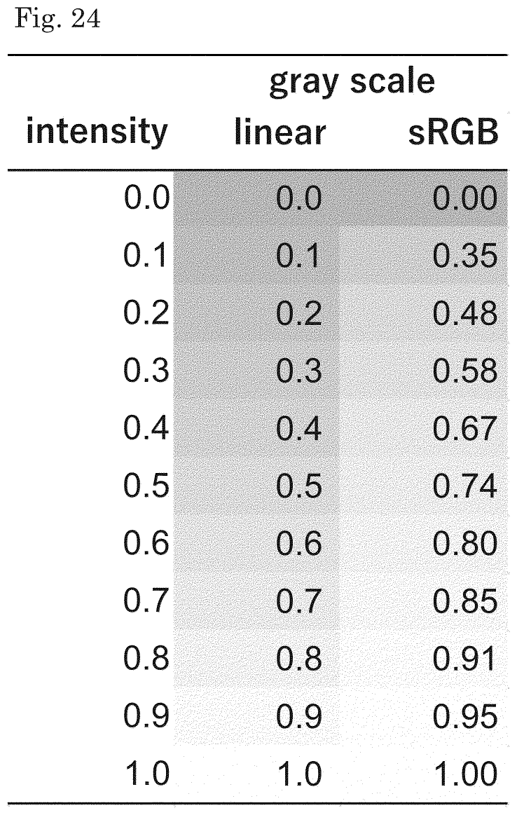

As light becomes darker, the human visual sensitivity tends to be higher. This will be described with reference to FIG. 24. FIG. 24 is a table for indicating the correlation between the luminance of light and the grayscale. As shown in FIG. 24, when the luminance (intensity) of light decreases stepwise, the grayscale in the sRGB standard has a larger difference at lower luminance as compared to the case where the grayscale changes linearly.

For example, the sRGB value for a luminance value of 0.8 is 0.91, and the sRGB value for a luminance value of 0.9 is 0.95. The difference between the sRGB values is 0.04. In other words, the difference in luminance tends to be less perceivable in this case.

Meanwhile, for example, the sRGB value for a luminance value of 0.1 is 0.35, and the sRGB value for a luminance value of 0.0 is 0.00. The difference between the sRGB values is 0.35. In other words, the difference in luminance tends to be more perceivable in this case.

As in the foregoing, the luminance distribution shown in FIG. 23B is different from the perceived luminance distribution shown in FIG. 23C.

The linearly varying grayscale and the sRGB standard grayscale can be converted using the following expressions (3) and (4), where C indicates the intensity of light. The expression (3) is a conversion expression when the light intensity of the sRGB standard, C_{sRGB} is at most 0.04045. The expression (4) is a transformation expression when the sRGB standard light intensity C_{sRGB} is greater than 0.04045.

$$\begin{matrix}[ Math . 3 ] & \\ {C}_{linear} = \frac{{C}_{s R G B}}{12.92} & ( 3 )\end{matrix}$$

$$\begin{matrix}[ Math . 4 ] & \\ {C}_{linear} = {( \frac{{C}_{s R G B} + 0.055}{12.92} )}^{2.4} & ( 4 )\end{matrix}$$

The above description of the light guide plate according to the ninth embodiment of the present technology may be applied to other embodiments of the present technology unless there is any particular technical contradiction.

### 10. Tenth Embodiment (Example 10 of Light Guide Plate)

Preferably, at least one grating group has a transition region at an end, and the diffraction efficiency of the transition region is preferably between the diffraction efficiency in an approximate center of the diffraction grating group and the diffraction efficiency in an approximate center of the diffraction grating group adjacent to the diffraction grating group.

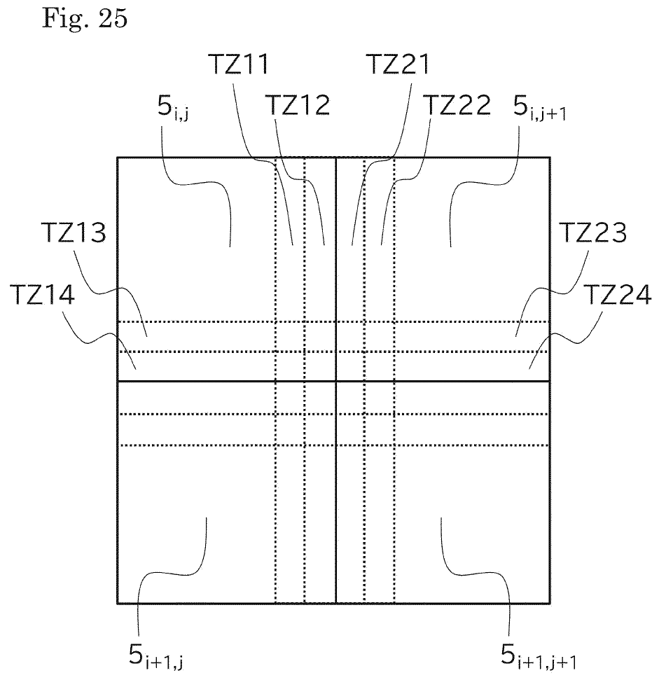

This will be described with reference to FIG. 25. FIG. 25 is a simplified front view of an exemplary configuration of the diffraction grating group 5 according to an embodiment of the present technology.

As shown in FIG. 25, at least one grating group 5 has transition regions TZ at ends. For example, a diffraction grating group 5_{i,j} has transition regions TZ11, TZ12, TZ13, and TZ14 at ends. A diffraction grating group 5_{i,j+1} has transition regions TZ21, TZ22, TZ23, and TZ24 at ends. The number of transition regions TZ is not limited.

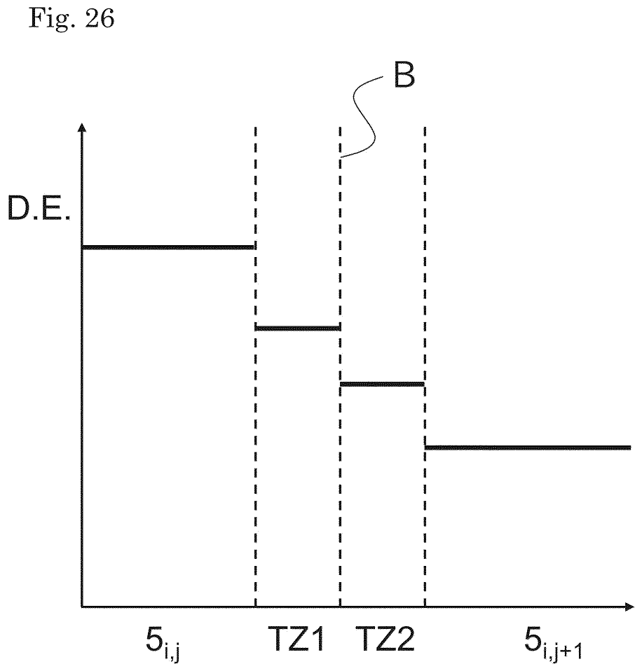

The diffraction efficiency of the transition region TZ is preferably between the diffraction efficiency in the approximate center of the diffraction grating group and the diffraction efficiency in an approximate center of a diffraction grating group adjacent to the diffraction grating group. This will be described with reference to FIG. 26. FIG. 26 is a graph for depicting an example of the diffraction efficiency of the diffraction grating group 5 according to the embodiment of the present technology. In FIG. 26, the abscissa indicates the diffraction grating group 5 and the transition region TZ. The ordinate indicates the diffraction efficiency of each of the diffraction grating groups 5 and the transition regions TZ.

In this example, the diffraction grating group 5_{i,j} has a transition region TZ1 at an end. The diffraction grating group 5_{i,j+1} has a transition region TZ2 at an end. The boundary line B between the diffraction grating group 5_{i,j} and the diffraction grating group 5_{i,j+1} is shown.

As shown in the figure, the diffraction efficiency of the transition region TZ1 is between the diffraction efficiency in the approximate center of the diffraction grating group 5_{i,j} and the diffraction efficiency in the approximate center of the diffraction grating group 5_{i,j+1} adjacent to the diffraction grating group 5_{i,j}. The diffraction efficiency of the transition region TZ2 is between the diffraction efficiency in the approximate center of the diffraction grating group 5_{i,j+1} and the diffraction efficiency in the approximate center of the diffraction grating group 5_{i,j} adjacent to the diffraction grating group 5_{i,j+1}. Stated differently, the diffraction efficiency decreases stepwise from the approximate center of the diffraction grating group 5_{i,j} to the approximate center of the diffraction grating group 5_{i,j+1}. In this example, the diffraction efficiency changes stepwise, but the diffraction efficiency may continuously change. Referring back to FIG. 25, the diffraction efficiency may change from the approximate center of the diffraction grating group 5_{i,j} to the approximate center of the diffraction grating group 5_{i,j+1}, from the approximate center of the diffraction grating group 5_{i,j} to the approximate center of the diffraction grating group 5_{i+1,j}, or from the approximate center of the diffraction grating group 5_{i,j} to the approximate center of the diffraction grating groups 5_{i+1,j+1}.

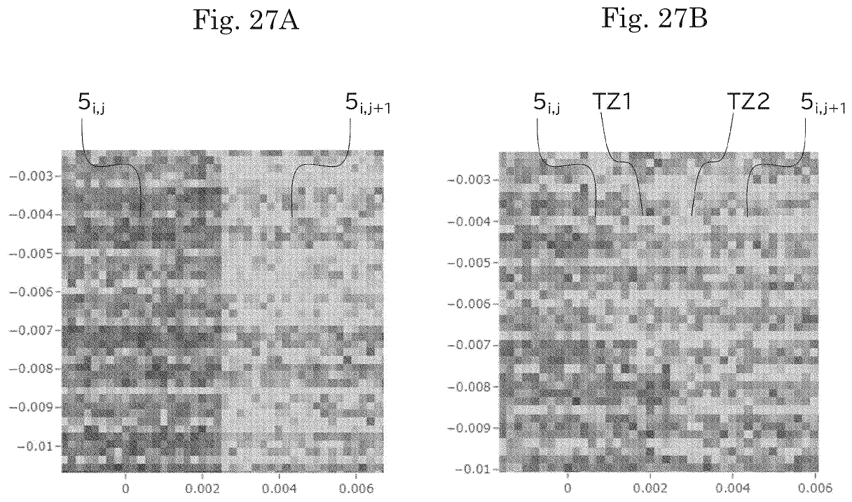

Advantageous effects of the present technology will be described with reference to FIG. 27. FIG. 27 illustrates simulation results according to the embodiment of the present technology. FIG. 27A shows a comparative example with respect to the present technology and shows a simulation result obtained when a diffraction grating group does not have a transition region at an end. As shown in FIG. 27A, the diffraction efficiency of the diffraction grating group 5_{i,j} and the diffraction efficiency of the diffraction grating group 5_{i,j+1} are different, so that the boundary line between the diffraction grating group 5_{i,j} and the diffraction grating group 5_{i,j+1} is clear. This has resulted in a decrease in the image quality.

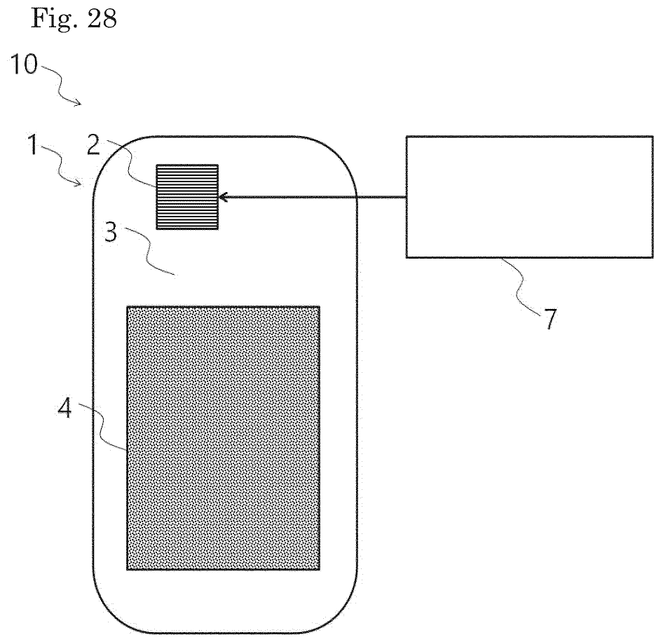

Meanwhile, FIG. 28B shows a comparative example with respect to the present technology and shows a simulation result obtained when the diffraction grating groups do not have transition regions at ends. As shown in FIG. 28B, the diffraction efficiencies of the diffraction grating groups 5_{i,j} and the diffraction efficiency of the diffraction grating group 5_{i,j+1} are different, but since the transition regions TZ1 and TZ2 are present, the boundary line between the diffraction grating groups 5_{i,j} and 5_{i,j+1} is not clear. This has reduced degradation in the image quality.

The above description of the light guide plate according to the tenth embodiment of the present technology can be applied to other embodiments of the technology unless there is any particular technical contradiction.

### 11. Eleventh Embodiment (Example of Image Display Device)

According to the present technology, provided is an image display device including a light guide plate according to the first to the tenth embodiments and an image forming unit that emits image light onto the light guide plate. This will be described with reference to FIG. 28. FIG. 28 is a block diagram of an exemplary configuration of an image display device 10 according to an embodiment of the present technology. As shown in FIG. 28, the image display device 10 according to the embodiment of the present technology includes a light guide plate 1 and an image forming unit 7 that emits image light onto the light guide plate 1.

The image forming unit 7 forms image light. The image forming unit 7 can use a micropanel to produce images in the image forming unit 7. For example, the micropanel can be a self-luminous panel such as a micro-LED or micro-OLED. Reflective or transmissive liquid crystals and LED (Light Emitting Diode) light sources or LD (Laser Diode) light sources may be used in combination with illumination optics.

Image light emitted from the image forming unit 7 is converted to a substantially collimated light for example by a projection lens (not shown) and is then focused on the incident part 2 and then incident on the light guide plate 1.

The image display device 10 can be for example a head-mounted display (HMD) worn on the user's head. Alternatively, the image display device 10 may be provided in a prescribed location as an infrastructure.

The above description of the light guide plate according to the eleventh embodiment of the present technology can be applied to other embodiments of the technology unless there is any particular technical contradiction.

Note that the embodiments of the present technology are not limited to those described above, and various modifications can be made without departing from the gist of the present technology.

In addition, the present technology can also have the following configurations.

[1]

A light guide plate including an incident part configured to diffract incident light into the light guide plate,
a path configured to guide the light diffracted into the light guide plate by the incident part by internal total reflection, and
an output part configured to diffract the light guided by the path and output the light toward an observer's pupil,
the output part having a plurality of diffraction grating groups in two-dimensional arrangement, the plurality of diffraction grating groups including, in front view,
at least one of a diffraction grating configured to diffract the light outward from the output part,
a diffraction grating configured to diffract the light inwardly with respect to the output part, and
a diffraction grating configured to diffract the light toward an observer's pupil.
   [2]

The light guide plate according to [1], wherein each of the diffraction grating diffracts the light in a two-dimensional direction.

[3]

The light guide plate according to [1] or [2], wherein the sum of a lattice vector which the incident part has and a basic lattice vector which the output part has is closed.

[4]

The light guide plate according to any one of [1] to [3], wherein the diffraction grating groups arranged adjacent to each other have lattice vectors substantially in the same direction.

[5]

The light guide plate according to any one of [1] to [4], wherein the diffraction grating groups has a plurality of unit diffraction gratings in a two-dimensional arrangement.

[6]

The light guide plate according to [5], wherein the unit diffraction gratings include a combination of periodic structures of diffraction gratings which the output part has.

[7]

The light guide plate according to [5] or [6], wherein the unit diffraction grating has a shape which substantially continuously changes from one side to the other in a plane of the output part.

[8]

The light guide plate according to any one of [1] to [7], wherein the diffraction grating groups have different shapes according to locations in a plane of the output part.

[9]

The light guide plate according to any one of [5] to [8], wherein each of the unit diffraction gratings have different shapes according to locations in a plane of the output part.

[10]

The light guide plate according to any one of [1] to [9], wherein the diffraction grating group has a return diffraction grating configured to diffract the light inwardly with respect to the output part, and
the return diffraction grating has a pitch which is a value obtained by dividing, by an integer, the pitch of other diffraction gratings which the output part has.
   [11]

The light guide plate according to [10], wherein the diffraction grating group including the return diffraction grating is provided outside of a region on which light from the path is incident and in an outer periphery of the output part.

[12]

The light guide plate according to [10] or [11], wherein the return diffraction grating has a stripe-like periodic structure.

[13]

The light guide plate according to any one of [5] to [12], wherein each of the unit diffraction grating has a hole pattern or a pillar pattern.

[14]

The light guide plate according to any one of [1] to [13], wherein the output part is provided on one or both surfaces of the light guide plate.

[15]

The light guide plate according to any one of [1] to [14], wherein the output part is provided in a location which is the same as or different from the incident part in a thickness-wise direction of the light guide plate.

[16]

The light guide plate according to any one of [1] to [15], including one or more of the incident parts, and one or more of the output parts.

[17]

The light guide plate according to any one of [1] to [16], further including an extension part between the incident part and the output part, wherein
the extension part has a plurality of diffraction grating groups in a two-dimensional arrangement,
the plurality of diffraction grating groups include, in front view,
at least one of a diffraction grating configured to diffract the light outward from the output part,
a diffraction grating configured to diffract the light inwardly with the respect to the output part, and
a diffraction grating configured to diffract the light toward the output part.
   [18]

The light guide plate according to [17], wherein the extension part and the output part are arranged adjacent to each other.

[19]

The light guide plate according to any one of [1] to [18], wherein the plurality of diffraction grating groups have a smaller spacing than the observer's pupil diameter.

[20]

The light guide plate according to [19], wherein the plurality of diffraction grating groups have a spacing that is approximately at most a half of the observer's pupil diameter.

[21]

The light guide plate according to [20], wherein the plurality of diffraction grating groups have a spacing that is approximately at most ¼ of the observer's pupil diameter.

[22]

The light guide plate according to [21], wherein the plurality of diffraction grating groups have a spacing that is approximately at most ⅛ of the observer's pupil diameter.

[23]

The light guide plate according to any one of [1] to [19], wherein the plurality of diffraction grating groups have a spacing of at most 3.0 mm.

[24]

The light guide plate according to any one of [1] to [20], wherein the plurality of diffraction grating groups have a spacing of at most 1.5 mm.

[25]

The light guide plate according to any one of [1] to [21], wherein the plurality of diffraction grating groups have a spacing of 0.75 mm or less.

[26]

The light guide plate according to any one of [1] to [19], wherein the plurality of diffraction grating groups have a spacing of 2.0 mm or less.

[27]

The light guide plate according to any one of [1] to [20], wherein the plurality of diffraction grating groups have a spacing of 1.0 mm or less.

[28]

The light guide plate according to any one of [1] to [21], wherein the plurality of diffraction grating groups have a spacing of 0.5 mm or less.

[29]

The light guide plate according to any one of [1] to [28], wherein at least one of the diffraction grating groups has a transition region at an end thereof,
the transition region has a diffraction efficiency which is between a diffraction efficiency in an approximate center of the diffraction grating group and a diffraction efficiency in an approximate center of a diffraction grating group adjacent to the diffraction grating group.
   [30]

An image display device including the light guide plate according to any one of [1] to [29], and an image forming unit that outputs image light to the light guide plate.

### REFERENCE SIGNS LIST

1 Light guide plate
2 Incident part
3 Path
4 Output part
5 Diffraction grating group
51 Unit diffraction grating
6 Extension part
7 Image forming unit
10 Image display device

What is claimed is:

1. A light guide plate, comprising:
an incident part configured to diffract incident light into the light guide plate;
a path configured to guide the light diffracted into the light guide plate by the incident part by internal total reflection; and
an output part configured to diffract the light guided by the path and output the light toward an observer's pupil,
the output part having a plurality of diffraction grating groups in two-dimensional arrangement,
the plurality of diffraction grating groups including, in front view,
at least one of a diffraction grating configured to diffract the light outward from the output part,
a diffraction grating configured to diffract the light inwardly with respect to the output part, and
a diffraction grating configured to diffract the light toward the observer's pupil.

2. The light guide plate according to claim 1, wherein each of the diffraction grating diffracts the light in a two-dimensional direction,
the sum of a lattice vector which the incident part has and a basic lattice vector which the output part has is closed, and
the diffraction grating groups arranged adjacent to each other have lattice vectors substantially in the same direction.

3. The light guide plate according to claim 1, wherein the diffraction grating groups has a plurality of unit diffraction gratings in a two-dimensional arrangement.

4. The light guide plate according to claim 3, wherein each of the unit diffraction grating include a combination of periodic structures of diffraction gratings which the output part has.

5. The light guide plate according to claim 3, wherein each of the unit diffraction grating has a shape which substantially continuously changes from one side to the other in a plane of the output part.

6. The light guide plate according to claim 1, wherein the diffraction grating groups have different shapes according to locations in a plane of the output part.

7. The light guide plate according to claim 3, wherein each of the unit diffraction grating have different shapes according to locations in a plane of the output part.

8. The light guide plate according to claim 1, wherein the diffraction grating group has a return diffraction grating configured to diffract the light inwardly with respect to the output part, and
the return diffraction grating has a pitch which is a value obtained by dividing, by an integer, the pitch of other diffraction gratings which the output part has.

9. The light guide plate according to claim 8, wherein the diffraction grating group including the return diffraction grating is provided outside of a region on which light from the path is incident and in an outer periphery of the output part.

10. The light guide plate according to claim 8, wherein the return diffraction grating has a stripe-like periodic structure.

11. The light guide plate according to claim 3, wherein each of the unit diffraction grating has a hole pattern or a pillar pattern.

12. The light guide plate according to claim 1, wherein the output part is provided on one or both surfaces of the light guide plate.

13. The light guide plate according to claim 1, wherein the output part is provided in a location which is the same as or different from the incident part in a thickness-wise direction of the light guide plate.

14. The light guide plate according to claim 1, comprising one or more of the incident parts, and
one or more of the output parts.

15. The light guide plate according to claim 1, further comprising an extension part between the incident part and the output part, wherein
the extension part has a plurality of diffraction grating groups in a two-dimensional arrangement,
the plurality of diffraction grating groups include, in front view,
at least one of a diffraction grating configured to diffract the light outward from the output part,
a diffraction grating configured to diffract the light inwardly with the respect to the output part, and
a diffraction grating configured to diffract the light toward the output part.

16. The light guide plate according to claim 15, wherein the extension part and the output part are arranged adjacent to each other.

17. The light guide plate according to claim 1, wherein the plurality of diffraction grating groups have a smaller spacing than the observer's pupil diameter.

18. The light guide plate according to claim 1, wherein the plurality of diffraction grating groups have a spacing of 3.0 mm or less.

19. The light guide plate according to claim 1, wherein at least one of the diffraction grating groups has a transition region at an end thereof, and
the transition region has a diffraction efficiency which is between a diffraction efficiency in an approximate center of the diffraction grating group and a diffraction efficiency in an approximate center of a diffraction grating group adjacent to the diffraction grating group.

20. An image display device comprising the light guide plate according to claim 1, and
an image forming unit that outputs image light to the light guide plate.
